(19) United States
(12) Patent Application Publication
(10) Pub. No.: US 2012/0000595 A1
(43) Pub. Date: Jan. 5, 2012

(54) METHOD FOR MANUFACTURING A DROPLET DISCHARGE HEAD

(75) Inventors: Atsushi MASE, Nagoya-City (JP); Hidehiko Tanaka, Nagoya-City (JP); Hideki Shimizu, Ohbu-City (JP)

(73) Assignee: NGK Insulators, Ltd., Nagoya-City (JP)

(21) Appl. No.: 13/118,836

(22) Filed: May 31, 2011

(30) Foreign Application Priority Data
Jun. 4, 2010 (JP) 2010-128581

(51) Int. Cl. C04B 33/32; C04B 37/00

(52) U.S. Cl. 156/89.11

(57) ABSTRACT

In a method for manufacturing a droplet discharge head, a first mold is prepared having first convexity portions shaped like pressure chambers of the droplet discharge head. A slurry is filled into the first mold, and the first mold is placed on a first porous plate. A solvent included in the slurry permeates into the first porous plate. The slurry is dried to form a first compact. Similarly, a second mold is prepared which has second convexity portions shaped like nozzle sections of the droplet discharge head. The slurry is filled into the second mold, and the second mold is placed on a second porous plate. The solvent included in the slurry permeates into the second porous plate. The slurry is dried to form a second compact. Thereafter, the first compact and the second compact are press bonded and fired.

### FIELD OF THE INVENTION

The present invention relates to a method for manufacturing a droplet discharge head, which discharges a droplet of, for example, a liquid containing DNA, a liquid material, a liquid fuel, and the like.

### BACK GROUND OF THE INVENTION

Conventionally, a ceramic layered body having in its inside a hollow cavity, which is, for example, a pressure chamber for pressurizing a liquid, has been known. Such a ceramic layered body is used in a wide variety of fields including, for example, an apparatus for producing a DNA chip, an “actuator for injection a liquid” such as a fuel injection device, and the like, an actuator for an ink jet printer, a solid-oxide fuel cell (SOFC), a switching device, a sensor, and so on (refer to Patent document 1).

Generally, such a ceramic layered body is manufactured according to procedures described below.

(1) Ceramic green sheets are prepared.

(2) A through hole having a predetermined shape is formed in the ceramic green sheet by punching using “a mold and a die”.

(3) The ceramic green sheets each having the formed through hole and the ceramic green sheets each having no through hole are stacked (layered).

(4) A plurality of the layered green sheets are fired to be united (integrated).

### RELATED ART

### Patent Document

[Patent Document 1] Japanese Patent No. 3600198

### SUMMARY OF THE INVENTION

However, punching using a mold and a die forms the through hole by sheering. Accordingly, when the ceramic green sheet is punched through, a large force is applied to the ceramic green sheet. As a result, a fracture surface becomes rough, or a burr and a crack may be generated. Especially, when the pressure chamber (cavity) is miniaturized, the deformation, the burr, the crack, and the like may cause great adverse effects on a shape accuracy of the pressure chamber (cavity). Further, “the mold and the die” need to have hardness to endure the punching, and therefore, they are formed of a material having high hardness. Since it is difficult to produce a miniaturized mold and a miniaturized die using the material having high hardness, there is a limit on miniaturizing the pressure chamber (cavity).

The present invention is made to cope with the problems described above. That is, one of the objects of the present invention is to provide a “method for manufacturing a droplet discharge head”, which allows to manufacture a droplet discharge head having an excellent shape accuracy, even if the pressure chamber is miniaturized, or a distance between the pressure chambers adjacent to each other is short.

One of the methods for manufacturing a droplet discharge head (hereinafter, referred to as a “present manufacturing method”) according to the present invention in order to achieve the object described above is a manufacturing method for manufacturing a droplet discharge head including a “droplet discharge head body comprising a pressure chamber for retaining/storing liquid and a nozzle section communicating with the pressure chamber”.

The present manufacturing method includes (1) slurry preparing step, (2) first mold preparing step, (3) first porous plate preparing step, (4) first compact forming step, (5) second mold preparing step, (6) second porous plate preparing step, (7) second compact forming step, (8) head-body-before-fired forming step, and (9) firing step.

(1) Slurry preparing step:

The slurry preparing step is a step for preparing a slurry including ceramic powders, a solvent (resolvent) for the ceramic powders, and an organic material.

(2) First mold preparing step:

The first mold preparing step is a step for preparing a first mold including a first base portion having at least one flat (plain) surface, and a first convexity portion having a convexity which stands (is held upright, or erects) from the flat surface of the first base portion and has the substantially same shape as the pressure chamber. A molding surface of the first mold is composed of a portion of the flat surface of the first base portion at which the first convexity portion does not exist, and a surface of the first convexity portion.

(3) First porous plate preparing step:

The first porous plate preparing step is a step for preparing a first porous plate, having at least one flat surface, through which gases can pass.

(4) First compact forming step:

The first compact forming step is a step for forming a first-compact-after-dried (dried first compact) by placing the first porous plate and the first mold in such a manner that they are opposite (face) to each other while the slurry is maintained (or kept, held) between “the flat surface of the first porous plate and the molding surface of the first mold”, and drying the slurry through having the solvent included in the slurry permeate into fine pores of the first porous plate.

(5) Second mold preparing step:

The second mold preparing step is a step for preparing a second mold including a second base portion having at least one flat (plain) surface, and a second convexity portion having a convexity which stands (is held upright, or erects) from the flat surface of the second base portion and has the substantially same shape as the nozzle section. A molding surface of the second mold is composed of a portion of the flat surface of the second base portion at which the second convexity portion does not exist, and a surface of the second convexity portion.

(6) Second porous plate preparing step:

The second porous plate preparing step is a step for preparing a second porous plate, having at least one flat surface, through which gases can pass.

(7) Second compact forming step:

The second compact forming step is a step for forming a second-compact-after-dried (dried second compact) by placing the second porous plate and the second mold in such a manner that they are opposite (face) to each other while the slurry is maintained (or kept, held) between “the flat surface of the second porous plate and the molding surface of the second mold”, and drying the slurry through having the solvent included in the slurry permeate into fine pores of the second porous plate.

(8) Head-body-before-fired forming step:

The head-body-before-fired forming step is a step for joining the first compact and the second compact in such a manner that a “flat portion of the first compact, the flat portion formed by the flat surface of the first porous plate” and a “flat portion of the second compact, the flat portion formed by the flat surface of the second porous plate” are parallel to each other to thereby form (make, obtain) a droplet discharge head body-before-fired. Joining above can be performed by applying an adhesion layer including an adhesive, and the like. It is preferable to apply the aforementioned slurry for joining described above, from a viewpoint of reducing a “distortion due to a difference in shrinkage during firing”.

(9) Firing step:

The firing step is a step for firing the droplet discharge head body-before-fired.

As long as the slurry preparing step, the first mold preparing step, and the first porous plate preparing step are performed before the first compact forming step, these steps can be performed in any order. Similarly, as long as the slurry preparing step, the second mold preparing step, and the second porous plate preparing step are performed before the second compact forming step, these steps can be performed in any order. Further, as long as the first compact forming step and the second compact forming step are performed before the head-body-before-fired forming step, these steps can be performed in any order.

According to the manufacturing method described above, the pressure chamber is formed based on forming the slurry by the mold. Therefore, even when the pressure chamber is miniaturized, or the distance between the pressure chambers adjacent to each other is short, the droplet discharge head having an excellent shape accuracy can be manufactured. In addition, the nozzle section is formed based on forming the slurry by the mold. Therefore, a surface of the nozzle section is smooth, and burrs etc. are not generated. As a result, the droplet discharge head capable of stably discharging droplets can be provided.

Furthermore, according to the manufacturing method described above, an upper potion of the droplet discharge head (i.e., portion constituting the pressure chamber) and a lower portion of the droplet discharge head (i.e., portion constituting the nozzle section) are formed separately (independently). Therefore, an amount of and a thickness of the slurry to be dried in a single forming step can be made smaller (reduced), as compared to a case in which a single mold is used to dry and form the slurry in order to make the droplet discharge head body. Consequently, a time required to “dry and form” the slurry can be shorten.

In this case, the head-body-before-fired forming step may be a step for joining the first compact and the second compact in such a manner that the flat portion of the first compact contacts with the flat portion of the second compact.

According to this aspect described above, an upper (top) surface of the droplet discharge head body is a surface formed by the “flat surface of the first base portion of the first mold”. A lower (bottom) surface of the droplet discharge head body is a surface formed by the “flat surface of the second base portion of the second mold”. Therefore, since the surface flatness of the top and the bottom surfaces of the droplet discharge head body is high, it is possible to solidly join another member (e.g., a vibration plate, a cover member, a member having a through hole described later, and the like) onto the upper surface or the lower surface of the droplet discharge head body.

Further, in this case, it is preferable that the method include an other member joining step for joining a member having a through hole onto a surface (lower surface of the droplet discharge head body) in a side of the second compact of the droplet discharge head body which has been fired in such a manner that the through hole communicates with the nozzle section, after the firing step.

As described above, the lower (bottom) surfaces of the droplet discharge head body is the surface formed by the “flat surface of the second base portion of the second mold”, and therefore has a high flatness. Accordingly, another member having a through hole (nozzle tip portion) for discharging droplets can be solidly joined onto the lower surfaces of the droplet discharge head body.

Further, the head-body-before-fired forming step may include removing (or eliminating, deleting) a part of a first remnant formed by the flat surface of the first porous plate and a top surface of the first convexity portion, and a part of a second remnant formed by the flat surface of the second porous plate and a top surface of the second convexity portion, after joining the first compact and the second compact.

One of the other aspects of the method for manufacturing a droplet discharge head according to the present invention includes:

the slurry preparing step described above;

mold preparing step for preparing a mold including a base portion having at least one flat (plain) surface, and a convexity portion having a convexity which stands (is held upright, or erects) from the flat surface of the base portion and has the substantially same shape as the pressure chamber and the nozzle section, wherein a portion of the flat surface of the base portion at which the convexity portion does not exist and a surface of the convexity portion forms (constitutes) a molding surface;

porous plate preparing step similar to the first porous plate preparing step described above;

head-body-before-fired forming step for placing the porous plate and the mold in such a manner that the porous plate and the mold are opposed to each other while the slurry is maintained (or kept, held) between the flat surface of the porous plate and the molding surface of the mold, and drying the slurry through having the solvent included in the slurry permeate into fine pores of the porous plate, to thereby form (make, obtain) a droplet discharge head body-before-fired; and

firing step for firing the droplet discharge head body-before-fired.

According to the method described above, the droplet discharge head body is formed (made, produced) using a single mold. It is therefore unnecessary to join two compacts to form the droplet discharge head body. Thus, the steps can be simplified. Further, it is unnecessary to join two compacts by pressure bonding while aligning those two compacts in order to form the droplet discharge head body. Therefore, the droplet discharge head having a desired shape can easily be manufactured. It should be noted that, as long as the slurry preparing step, the mold preparing step, and the porous plate preparing step are performed before the compact forming step, these steps can be performed in any order.

The above and other objects, features and associated advantages of the present invention will be easily understood better from the following description of each of embodiments according to the present invention with reference to the following drawings.

### BRIEF DESCRIPTION OF THE DRAWINGS

FIG. 1 includes (A) being a plan view of a droplet discharge head body manufactured using a method (first manufacturing method) for manufacturing a droplet discharge head of a first embodiment according to the present invention, and (B) being a cross-sectional view of the droplet discharge head manufactured using the first manufacturing method;

FIG. 2 includes (A) being a vertical cross-sectional view of a first mold used in the first manufacturing method, in a longitudinal direction (direction along a longer side) of the first mold, (B) being a vertical cross-sectional view of the first mold in a direction along a shorter side of the first mold, and (C) being a partial perspective view of the first mold;

FIG. 3 is a view for describing “a first porous plate preparing step and a first compact forming step” of the first manufacturing method;

FIG. 4 is another view for describing the first compact forming step of the first manufacturing method;

FIG. 5 is another view for describing the first compact forming step of the first manufacturing method;

FIG. 6 is a cross-sectional view of the first compact which is formed through the first compact forming step of the first manufacturing method;

FIG. 7 includes (A) being a vertical cross-sectional view of a second mold used in the first manufacturing method, in a longitudinal direction (direction along a longer side) of the second mold, (B) being a vertical cross-sectional view of the second mold in a direction along a shorter side of the second mold, and (C) being a partial perspective view of the second mold;

FIG. 8 is a view for describing “a second porous plate preparing step and a second compact forming step” of the first manufacturing method;

FIG. 9 is another view for describing the second compact forming step of the first manufacturing method;

FIG. 10 is another view for describing the second compact forming step of the first manufacturing method;

FIG. 11 is a cross-sectional view of the second compact which is formed through the second compact forming step of the first manufacturing method;

FIG. 12 is a view for describing a head-body-before-fired forming step of the first manufacturing method;

FIG. 13 is another view for describing the head-body-before-fired forming step of the first manufacturing method;

FIG. 14 is another view for describing the head-body-before-fired forming step of the first manufacturing method;

FIG. 15 is a magnified photograph of a nozzle section formed by a conventional punching process;

FIG. 16 is a magnified photograph of a nozzle section formed by the first manufacturing method;

FIG. 17 is another magnified photograph of the nozzle section formed by the first manufacturing method;

FIG. 18 includes (A) being a vertical cross-sectional view of a first mold used in a method (second manufacturing method) for manufacturing a droplet discharge head of a second embodiment according to the present invention in a longitudinal direction (direction along a longer side) of the first mold, (B) being a vertical cross-sectional view of the first mold in a direction along a shorter side of the first mold, and (C) being a partial perspective view of the first mold;

FIG. 19 is a view for describing “a first porous plate preparing step and a first compact forming step” of the second manufacturing method;

FIG. 20 is another view for describing the first compact forming step of the second manufacturing method;

FIG. 21 is another view for describing the first compact forming step of the second manufacturing method;

FIG. 22 is a cross-sectional view of the first compact which is formed through the first compact forming step of the second manufacturing method;

FIG. 23 is a view for describing a head-body-before-fired forming step of the second manufacturing method;

FIG. 24 is another view for describing the head-body-before-fired forming step of the second manufacturing method;

FIG. 25 is another view for describing the head-body-before-fired forming step of the second manufacturing method;

FIG. 26 includes (A) being a plan view of a droplet discharge head body manufactured according to the second manufacturing method, and (B) being a cross-sectional view of the droplet discharge head manufactured according to the second manufacturing method;

FIG. 27 includes (A) being a vertical cross-sectional view of a mold (third mold) used in a method (third manufacturing method) for manufacturing a droplet discharge head of a third embodiment according to the present invention in a longitudinal direction (direction along a longer side) of the mold, (B) being a vertical cross-sectional view of the third mold in a direction along a shorter side of the third mold, and (C) being a partial perspective view of the third mold;

FIG. 28 is a view for describing “a porous plate preparing step and a compact forming step” of the third manufacturing method;

FIG. 29 is another view for describing the compact forming step of the third manufacturing method;

FIG. 30 is another view for describing the compact forming step of the third manufacturing method;

FIG. 31 is a cross-sectional view of the compact which is formed through the compact forming step of the third manufacturing method;

FIG. 32 is a view for describing a head-body-before-fired forming step of the third manufacturing method;

FIG. 33 is a partially magnified photograph of the droplet discharge head body manufactured according to the third manufacturing method;

FIG. 34 is a view for describing a way to remove a remnant membrane (residual film) in a modified embodiment of the third manufacturing method;

FIG. 35 is a cross-sectional view of the droplet discharge head body-before-fired which is formed according to the modified embodiment of the third manufacturing method;

FIG. 36 is a view for describing a way to remove a remnant membrane (residual film) according to a modified first manufacturing method and a modified second manufacturing method;

FIG. 37 is a cross-sectional view of the second compact-after-dried which is formed according to the modified first manufacturing method and the modified second manufacturing method;

FIG. 38 is a view for describing a method for manufacturing a droplet discharge head according to a modified embodiment (modified example) of the present invention; and

FIG. 39 is a view for describing a method for manufacturing a droplet discharge head according to a modified embodiment of the first embodiment (modified example of the first embodiment) of the present invention.

### DESCRIPTION OF THE EMBODIMENTS CARRYING OUT THE INVENTION

Next will be described methods for manufacturing a droplet discharge head according to embodiments of the present invention with reference to the drawings. It should be noted that performing order of the steps described below can be changed as long as there is no inconsistency.

### First Embodiment

First, a schematic structure will be described of a droplet discharge head 10 manufactured by a “method for manufacturing a droplet discharge head” according to a first embodiment of the present invention. Hereinafter, the manufacturing method according to the first embodiment is also referred to as a first manufacturing method.

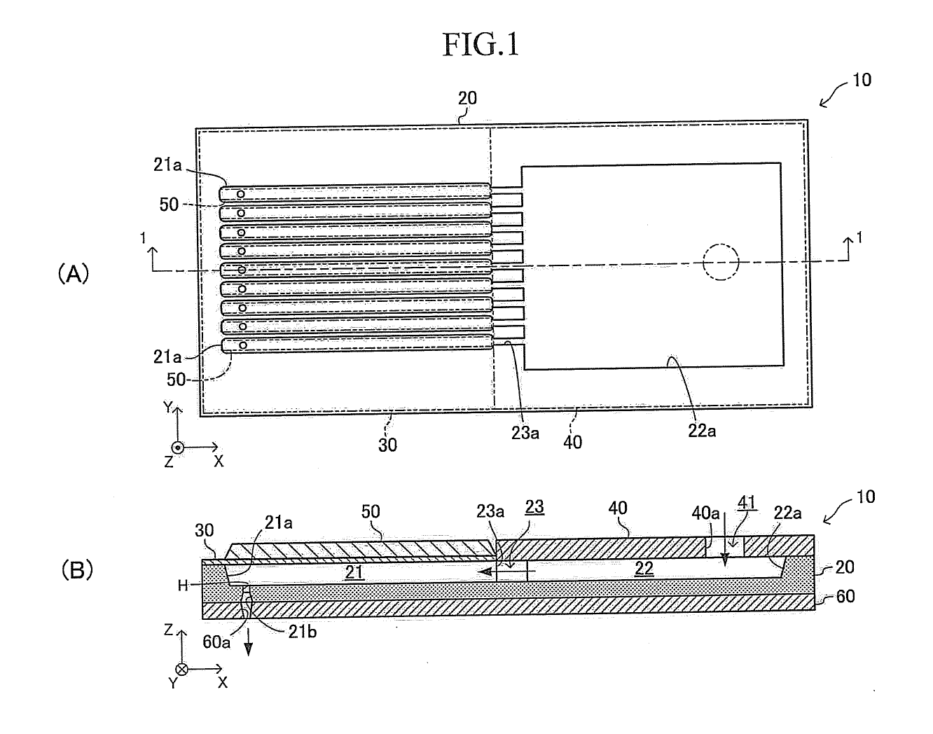

As shown in (A) and (B) of FIG. 1, the droplet discharge head 10 comprises a droplet discharge head body (head body) 20, a vibration plate 30, a liquid storage chamber cover member 40, a plurality (nine in the example shown in FIG. 1) of piezoelectric elements 50, and a discharge hole tip portion forming member 60. It should be noted that (A) of FIG. 1 is a plan view of the droplet discharge head 10 (that is, the head body 20) which is in a state in which the vibration plate 30, the liquid storage chamber cover member 40, the piezoelectric elements 50, and the discharge hole tip portion forming member 60 are removed. It should be also noted that (B) of FIG. 1 is a cross-sectional view of the droplet discharge head 10 cut by a plane along 1-1 line shown in the (A) of FIG. 1.

The head body 20 is formed of ceramic. The head body 20 has a rectangular parallelepiped shape having sides, each being parallel to one of X, Y and Z axes orthogonal to each other. That is, as shown (A) of FIG. 1, a shape of a planar view of the head body 20 (shape obtained when the head body 20 is viewed from a positive Z axis side along the Z axis) is rectangular. Long sides and short sides of the rectangle are parallel to the X axis and the Y axis, respectively. A direction of a thickness (height) of the head body 20 is parallel to the Z axis. It should be noted that, for convenience of description, a positive direction of the Z axis is defined as an upper direction, and a negative direction of the Z axis is defined as a lower direction, hereinafter.

A plurality (in the example shown in FIG. 1, nine) of groove sections (channels) 21a are provided (formed) which constitute a plurality of the pressure chambers 21, at an upper portion of the head body 20. A plurality of the groove sections 21 have the same shape as each other. Each of the groove sections 21 has a substantially rectangular parallelepiped shape.

More specifically, the groove section 21a has “long sides, each extending along the X-axis, and short sides, each extending along the Y-axis”, in a plan view. One of ends of the long side extending along the X-axis, of the groove section 21a is positioned at a position close to an X-axis negative direction end of the head body 20. The other one of the ends of the long side, extending along the X-axis, of the groove section 21a is positioned at a substantially center portion of the head body 20 in an X-axis direction. A bottom surface of the groove section 21a is a flat (plain) surface located at a substantially center portion of the head body 20 in a thickness direction of the head body 20. That is, a depth (height) of the groove section 21a is about a half of the thickness of the head body 20.

In the head body 20, “nozzle sections 21b and through holes H” are formed. Each of the nozzle sections 21b and each of the through holes H are provided at a position close to an X-axis negative direction end of the bottom surface of the groove section 21a. Each of the nozzle sections 21b has a circular truncated cone shape. Each of the through holes H has a cylindrical shape. The through holes H opens at the bottom surface of the groove section 21a, and the nozzle section 21b opens at a lower (bottom) surface of the head body 20. Each of the nozzle sections 21b and each of the through holes H are positioned coaxially. The nozzle sections 21b together with the through hole H provides a communication passage between the bottom surface of the groove section 21a and the lower surface of the head body 20. The nozzle sections 21b and the through hole H may also be referred to as a base side nozzle section.

A concave section 22a is formed for forming a liquid storage chamber (ink tank chamber) 22 at the upper portion of the head body 20. The concave section 22a has a substantially rectangular parallelepiped shape.

More specifically, the concave section 22a has “long sides, each extending along the X-axis, and short sides, each extending along the Y-axis”, in a plan view. One of ends of the long side, extending along the X-axis, of the concave section 22a is positioned at a position close to an X-axis positive direction end of the head body 20. The other one of the ends of the long side, extending along the X-axis, of the concave section 22a is positioned at the substantially center portion of the head body 20 in the X-axis direction, and is apart from the other one of the ends of the long side, extending along the X-axis, of the groove section 21a at a predetermined distance. One of the ends of the short side, extending along the Y-axis, of the concave section 22a is positioned at a portion in the side of Y-axis positive direction as compared to a Y-axis positive direction end of the short side of the groove section 21a which is positioned at the Y-axis positive direction end of the plurality of the groove sections 21a. The other one of the ends of the short side, extending along the Y-axis, of the concave section 22a is positioned at a portion in the side of Y-axis negative direction as compared to a Y-axis negative direction end of the short side of the groove section 21a which is positioned at the Y-axis negative direction end of the plurality of the groove sections 21a. A bottom surface of the concave section 22a is a flat (plain) surface located at the substantially center portion of the head body 20 in the thickness direction of the head body 20. That is, a depth (height) of the concave section 22a is the same as the depth (height) of the groove section 21a.

A plurality (in the example shown in FIG. 1, nine) of groove sections (channels) 23a are provided (formed) which constitute a plurality of liquid flow holes 23 at the upper portion of the head body 20. Each one of the groove sections 23a is provided so as to correspond to each one of the groove sections 21a. A plurality of the groove sections 23a have the same shape as each other. Each of the groove sections 23a has a substantially rectangular parallelepiped shape.

More specifically, each of the groove sections 23a has “long sides, each extending along the X-axis, and short sides, each extending along the Y-axis”, in a plan view. One of ends of the long side extending along the X-axis, of each of the groove sections 23a is extended to the “short side extending along the Y-axis” of one of the groove sections 21a, located at the X-axis positive direction end of the one of the groove sections 21a. The other one of the ends of the long side, extending along the X-axis, of each of the groove sections 23a is extended to the “short side extending along the Y-axis” of the concave section 22a, located at the X-axis negative direction end of the concave section 22a. A length of the short side extending along the Y-axis of each of the groove section 23a is smaller than a length of the short side extending along the Y-axis of each of the groove sections 21a. Each one of the groove sections 23a provides a communication passage between each one of the groove sections 21a and the concave section 22a. A bottom surface of each of the groove sections 23a is a flat (plain) surface located at the substantially center portion of the head body 20 in the thickness direction of the head body 20. A depth (height) of the groove section 23a is the same as the depth (height) of the groove section 21a.

The vibration plate 30 is a thin plate formed of a ceramic, having a small thickness (height) along the Z-axis direction. The vibration plate 30 is easily deformable. A shape of the vibration plate 30 in a plan view is a rectangle. A position of an X-axis positive direction end of the vibration plate 30 substantially coincides with the position of the X-axis positive direction ends of the groove sections 21a. A position of an X-axis negative direction end of the vibration plate 30 substantially coincides with the position of the X-axis negative direction end of the head body 20. “A Y-axis positive direction end and a Y-axis negative direction end” of the vibration plate 30 substantially coincide with “the Y-axis positive direction end and the Y-axis negative direction end” of the head body 20, respectively. The vibration plate 30 is disposed so as to contact with an upper surface of the head body 20. Accordingly, the vibration plate 30 covers upper portions of all of the groove sections 21a. Consequently, each of the pressure chambers 21 is formed (defined) by the bottom surface and side surfaces of each of the groove sections 21a together with a lower surface of the vibration plate 30.

The liquid storage chamber cover member 40 is a plate formed of a ceramic, having a thickness (height) along the Z-axis direction. A shape of the liquid storage chamber cover member 40 in a plan view is a rectangle. A position of an X-axis positive direction end of the liquid storage chamber cover member 40 substantially coincides with the position of the X-axis positive direction ends of the head body 20. A position of an X-axis negative direction end of the liquid storage chamber cover member 40 substantially coincides with the position of the X-axis positive direction end of the vibration plate 30. That is, the X-axis negative direction end of the liquid storage chamber cover member 40 is in close contact with the X-axis positive direction end of the vibration plate 30. “A Y-axis positive direction end and a Y-axis negative direction end” of the liquid storage chamber cover member 40 substantially coincide with “the Y-axis positive direction end and the Y-axis negative direction end” of the head body 20, respectively. The liquid storage chamber cover member 40 is disposed so as to contact with the upper surface of the head body 20. Accordingly, the liquid storage chamber cover member 40 covers an upper portion of the concave section 22a. Consequently, the liquid storage chamber 22 is formed (defined) by the bottom surface and side surfaces of the concave section 22a together with a lower surface of the liquid storage chamber cover member 40.

Further, the liquid storage chamber cover member 40 covers upper portions of all of the groove sections 23a. Consequently, each of the liquid flow holes 23 is formed (defined) by the bottom surface and side surfaces of each of the groove sections 23a together with the lower surface of the liquid storage chamber cover member 40. Each one of the liquid flow holes 23 provides a liquid passage which allows a liquid to flow (pass) between each one of the pressure chambers 21 and the liquid storage chamber 22.

A liquid supply through hole 40a is formed in the liquid storage chamber cover member 40. The liquid supply through hole 40a is provided at a substantially central portion of the liquid storage chamber cover member 40 in a plan view. The liquid supply through hole 40a provides a liquid passage which allows a liquid to flow (pass) between an exterior of the droplet discharge head body 20 and the liquid storage chamber 22.

Each of a plurality of the piezoelectric elements 50 has “long sides, each extending along the X-axis, and short sides, each extending along the Y-axis”, in a plan view. A shape of each of the piezoelectric elements 50 substantially coincides with the shape of each of the pressure chambers 21 (and thus, coincides with each of the groove sections 21a), in a plan view. Each of a plurality of the piezoelectric elements 50 is formed so as to oppose to each of the pressure chambers 21 to sandwich the vibration plate 30 therebetween.

The discharge hole tip portion forming member 60 is a plate formed of, in the present example, a metal (e.g., SUS), resins, and so on. An upper surface of the discharge hole tip portion forming member 60 is joined (bonded) to the lower surface of the head body 20. A plurality (in the example shown in FIG. 1, nine) of liquid discharge holes 60a are formed in the discharge hole tip portion forming member 60. Each of the liquid discharge holes 60a passes through (penetrate) the discharge hole tip portion forming member 60 in a thickness direction of the discharge hole tip portion forming member 60. The liquid discharge hole 60a is also referred to as a tip side nozzle section. A plurality of liquid discharge holes 60a have the same shape as each other. The liquid discharge holes 60a has an inverted circular truncated cone shape. Each of the liquid discharge holes 60a is provided in such a manner that each of the liquid discharge holes 60a and each of the nozzle sections 21b are positioned coaxially. Consequently, the liquid discharge holes 60a provides a communication passage between a tip (end) of the nozzle section 21b which opens at the lower surface of the head body 20 and a lower surface of the discharge hole tip portion forming member 60.

In the thus configured droplet discharge head 10, a liquid (e.g., ink) is supplied from the exterior of the droplet discharge head 10 to the liquid storage chamber 22 through the liquid supply through hole 40a. The liquid in the liquid storage chamber 22 is supplied to each of the pressure chambers 21 through each of the liquid flow holes 23. When the piezoelectric element 50 is deformed by means of an electric power supplied from an unillustrated power/drive source, the vibration plate 30 deforms. Consequently, the liquid in the pressure chamber 21 is pressurized (compressed) to thereby be discharged as a droplet from the lower surface of the droplet discharge head 10 through the through hole H, the nozzle section 21b (base side nozzle section), and the liquid discharge holes 60a (tip side nozzle section).

The first manufacturing method will next be described for each of steps.

### (Slurry Preparing Step)

Firstly, a slurry SL is prepared. The slurry SL consists of ceramic powders serving as particles of a main raw material, a solvent for the ceramic powders, an organic material, and a plasticizing agent. A ratio by weight of those is, for instance, the ceramic powder: the solvent: the organic material: the plasticizing agent=100: 50-100: 5-10: 2-5. In the present example, the ceramic powders are made of alumina, zirconia, and so on. The solvent is made of toluene, isopropyl alcohol, and so on. The organic material is made of polyvinyl butyral, and so on. The plasticizing agent is made of phthalate series butyl, and so on. Each of the materials and the weight ratio are not limited thereto. It should be noted that it is preferable that a viscosity of the slurry be, for example, 0.1-100 Pa·sec.

### (First Mold Preparing Step)

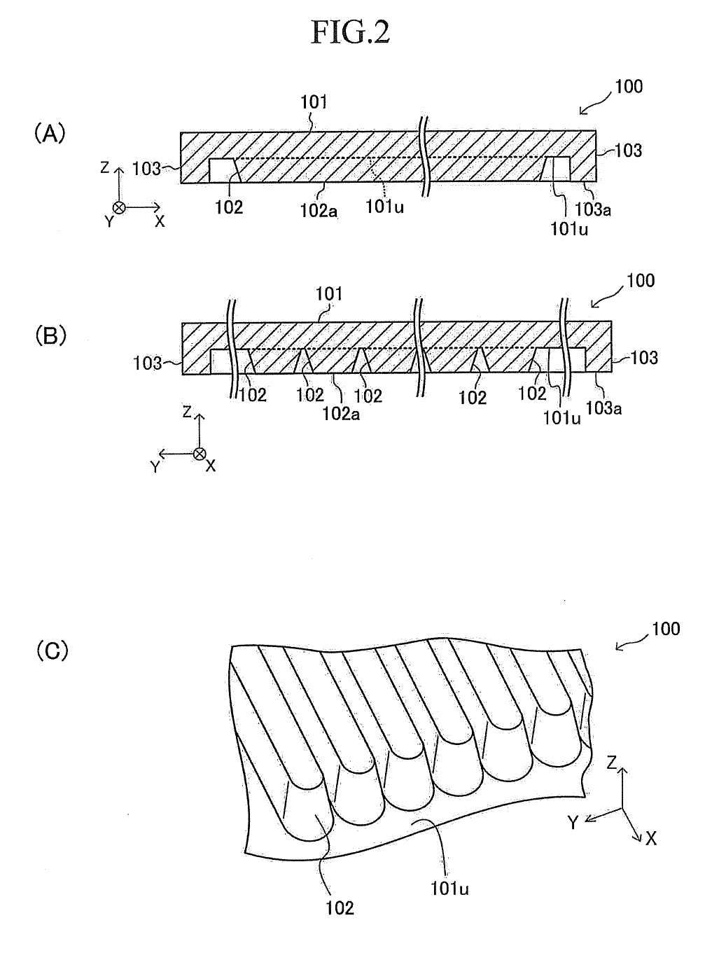

A first mold (a pressing mold, a stamper) 100 shown in (A) to (C) of FIG. 2 is prepared. The (A) of FIG. 2 is a cross-sectional view of the first mold 100 cut by a plane (X-Z plane) along a longitudinal direction (the X-axis direction) of the first mold 100. The (B) of FIG. 2 is a cross-sectional view of the first mold 100 cut by a plane (Y-Z plane) along a shorter side (Y-axis direction) of the first mold 100 at a “predetermined position in the side of the X-axis negative direction with respect to a central portion in the X-axis direction of the first mold 100”. The (C) of FIG. 2 is a partial perspective view of the first mold 100. The first mold 100 comprises a first base portion 101, first convexity portions 102, and a first frame portion 103.

The first base portion 101 is a substantially flat plate. Therefore, the first base portion 101 comprises at least one flat (plain) surface 101u.

The first convexity portions 102 stand (are held upright, or erect) from the flat surface 101u. The first convexity portions 102 have the substantially same shape as a shape defined by “the plurality of the groove sections 21a, the concave section 22a, and a plurality of the groove sections 23a”. That is, the first convexity portions 102 have the substantially same shape as a shape defined by “a plurality of the pressure chambers 21, the liquid storage chamber 22, and a plurality of the liquid flow holes 23”. In other words, the first convexity portions 102 are a convexity portion including convexities having the substantially same shape as the shape of a plurality of the pressure chambers 21 that are arranged parallel to each other.

The first frame portion 103 stands (is held upright, or erects) from the flat surface 101u at an entire outer circumference of the first base portion 101. A shape defined by inner side surfaces of the first frame portion 103 is the substantially same as a shape defined by an outer circumference of the head body 20. A distance between the flat surface 101u and a top surface 103a of the first frame portion 103 (i.e., height of the first frame portion 103) is the same as a distance between the flat surface 101u and a top surface 102a of each of the first convexity portions 102 (i.e., height of the first convexity portions 102).

A molding surface of the first mold 100 is composed of a portion (surface) of the flat surface 101u of the first base portion 101 where “the first convexity portions 102 and the first frame section 103” do not exist, surfaces of the first convexity portions 102, and the inner side surfaces of the first frame portion 103.

It is preferable that the molding surface of the first mold 100 be coated with a mold release agent. This is also applied to another molds including “a second mold 200 and a third mold 300” described later. In such a case, in order to improve adherence force between the mold and the mold release agent, it is preferable that the mold (molding surface of the mold, that is, mold release surface) be cleaned before the mold release agent is applied to the mold. The cleaning can be performed by an ultrasonic cleaning, an acid cleaning, a UV ozone cleaning, and so on. Preferably, the surface of the mold to be coated with the mold release agent (i.e. a cleaned surface) is cleaned at the atomic level. One of examples of the mold release agent is a fluorine series mold release agent such as “OPTOOL DSX” available from DAIKIN INDUSTRIES, Ltd. The mold release agent may be a silicon series mold release agent or a wax release agent. The mold release agent is applied by dipping, spraying, brushing and so on, and thereafter, is formed in the form of a film on the surface of the mold through a drying step and a washing step. The surface of the mold may be coated by an inorganic film treatment with a DLC (Diamond Like Carbon) coating. Further, the surface of the first mold 100 may be coated by a combination of the inorganic film treatment and the mold release agent treatment.

### (First Porous Plate Preparing Step)

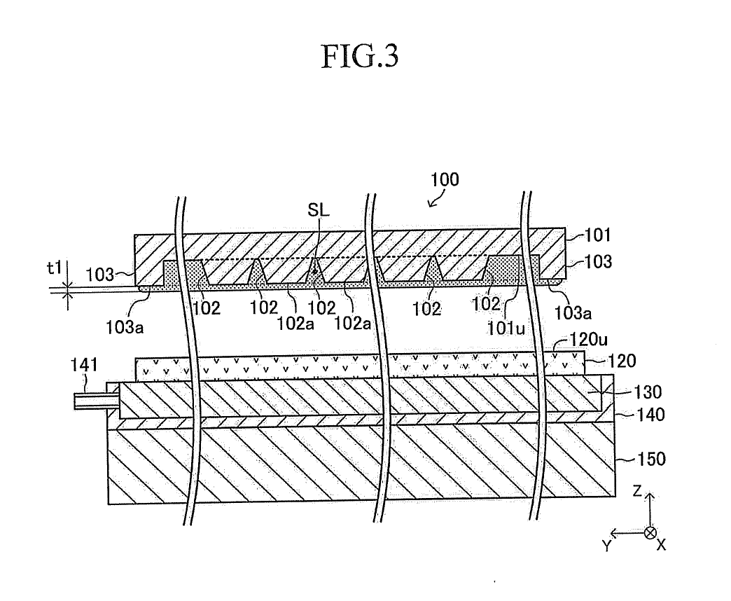

A first porous plate 120 through which gases can pass is prepared (refer to FIG. 3). At least one surface 120u of surfaces of the first porous plate 120 (in actuality, both surfaces) is flat (plain). One of typical examples of the porous plate is a porous film formed of resin. A diameter of the fine pore (an averaged diameter of the pores, fineness) of the first porous plate 120 is smaller than a particle diameter (an averaged particle diameter) of the ceramic powders, but is larger than a diameter of a molecule of the solvent. Specifically, the first porous plate 120 is a porous film formed of, for example, “polypropylene, polyolefin, and the like” whose diameter of the fine pores is equal to or smaller than 1 μm (more preferably, 0.5 μm). It should be noted that the first porous plate 120 may be a porous ceramic substrate, a porous metal (e.g., sintered metal) substrate, and so on.

### (First Compact Forming Step)

As shown in FIG. 3, the slurry SL is filled into an inside of the first frame portion 103 of the first mold 100. The slurry SL is filled by applying. This step is also referred to as a “first slurry filling (or applying) step”. The slurry SL may be filled by any of appropriate methods other than applying (e.g., dipping, squeegeeing, brushing, and filling with a dispenser, etc.). Further, in order to improve a filling rate of the slurry, ultrasonic vibration may be applied to the first mold 100, or air bubbles remaining in the first mold 100 may be removed by a vacuum deaeration, when filling the slurry SL into the inside of the first frame portion 103. Further, the slurry SL may be filled into the first mold 100 by impressing (pushing) the first mold 100 onto (against) a plate which is separately prepared while holding (maintaining) the slurry SL between the first mold 100 and the plate. The plate may be a PET film or the like to which a mold release treatment has been applied in order to avoid a transfer of the slurry SL to the plate (that is, in such a manner that the slurry filled in the first mold 100 does not remain on the plate when the first mold 100 is released/separated from the plate).

In this first slurry filling step, the slurry SL is filled into the first mold 100 in an amount more than necessary (i.e., an excessive amount of slurry SL is filled). This is because, a pressure (filling pressure) of the slurry SL while filling the slurry SL is increased (enhanced) to thereby improve the filling rate of the slurry SL. This is also because it is necessary to take into consideration shrinkage of the slurry SL when it is being dried. As a result, as shown in FIG. 3, the slurry SL is filled into the first mold 100 in such a manner that a surface of the slurry SL exists outside of the top surface 103a of the first frame portion 103 (see, a distance t1 shown in FIG. 3).

Meanwhile, as shown in FIG. 3, the first porous plate 120 is placed on an “upper surface of a porous sintered metal 130 (i.e., on one of both surfaces of the sintered metal 130)”. The sintered metal 130 is set (held) in a casing 140 which is made of a “dense and thermally conductive material”. That is, outer circumferences except its upper surface (i.e., side surfaces and a lower surface) of the sintered metal 130 are covered by the casing 140. A communicating pipe 141 for suction is inserted at and through a side portion of the casing 140. The communicating pipe 141 for suction is connected to a vacuum pump which is not shown.

The casing 140 is placed on a hot plate (a heating apparatus) 150. The hot plate 150 generates heat when energized to heat a lower surface of the first porous plate 120 (i.e., the other surface, or one portion of the first porous plate 120) through the casing 140 and the sintered metal 130.

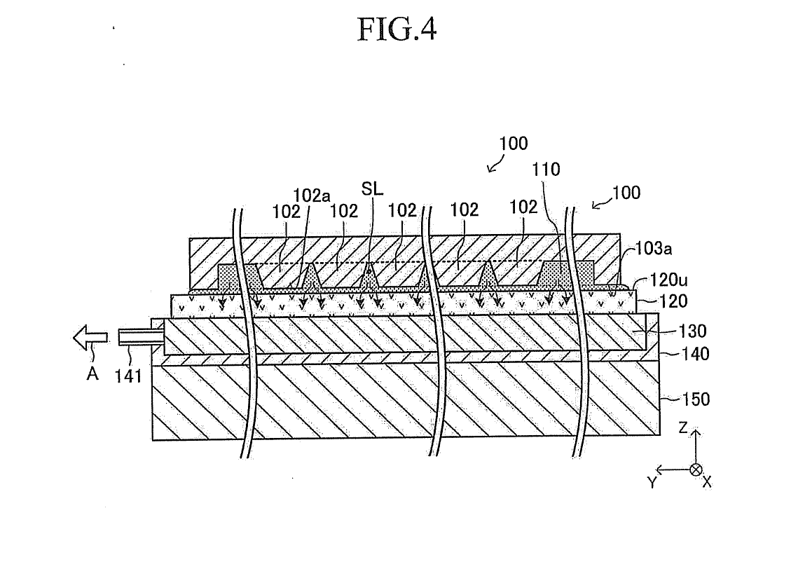

Subsequently, as shown in FIG. 4, the first porous plate 120 and the first mold 100 are set (placed) in such a manner that they are opposite (oppose, face) to each other while the slurry SL is maintained (or kept, held) between “the flat surface 120u of the first porous plate 120 and the molding surface of the first mold 100”. That is, the first mold 100 into which the slurry SL is filled is placed on the flat surface 120u of the first porous plate 120. At this time, the first mold 100 is pressed (impressed) against the first porous plate 120 with an appropriate force.

Consequently, as shown by arrows in FIG. 4, the solvent included in “the slurry SL kept in the first mold 100” permeates into the fine pores in the vicinity of the flat surface 120u of the first porous plate 120 (contact surface between the slurry SL and the first porous plate 120) by capillarity, and vaporizes (is evaporated). As a result, the slurry SL is dried.

Further, in this step, the aforementioned vacuum pump is driven. Driving the vacuum pump allows gases existing in the first porous plate 120 to be discharged (refer to white frame arrow A). Therefore, a pressure in the first porous plate 120 becomes lower than the atmospheric pressure (e.g., lower than the atmospheric pressure by 80 kPa). Thus, the solvent included in the slurry SL is sucked into the fine pores of the first porous plate 120 (especially, the pores in the vicinity of the surface of the first porous plate 120) (or, permeates into the fine pores and is dried) efficiently. In such a case, a degree of vacuum (the pressure in the first porous plate 120) is preferably 0 to −100 kPa, and more preferably −80 to −100 kPa.

It should be noted that it is more preferable that the sintered metal 130 and the first porous plate 120 be sealed up by covering “the exposed surface of the sintered metal 130 and the exposed surface of the first porous plate 120” with a gas tight film or the like, when the pressure in the fine pores of the first porous plate 120 is lowered by driving the vacuum pump. The exposed surface of the sintered metal 130 is a portion of the surface of the sintered metal 130 which is not covered by “the casing 140 and the first porous plate 120”. The exposed surface of the first porous plate 120 is a portion composed of the side surfaces of the first porous plate 120 and a portion of the flat surface (upper surface) 120u of the first porous plate 120 which is not covered by the first mold 100. If “the exposed surface of the sintered metal 130 and the exposed surface of the first porous plate 120” are not sealed up, the degree of vacuum of the first porous plate 120 decreases, and therefore, an efficiency in evaporation of the solvent becomes lowered. Further, a negative pressure is generated at portions from which the solvent of the slurry SL was evaporated, and therefore, air is introduced into the portions. As a result, air holes may be generated in the slurry SL in the vicinity of the first porous plate 120. In contrast, as described above, when “the exposed surface of the sintered metal 130 and the exposed surface of the first porous plate 120” are sealed up, the generation of such air holes can be prevented.

Furthermore, in this step, the hot plate 150 is energized. Therefore, a temperature of the first porous plate 120 increases, and thereby the solvent which has permeated into the fine pores of the first porous plate 120 can be easily evaporated (or diffused). As a result, the slurry SL is dried and becomes solidified, so that a first compact-after-dried 110 (first compact 110 which has been dried) is formed between “the first mold 100 and the first porous plate 120”.

It should be noted that, in this step, the hot plate 150 may be placed at an uppermost position, the casing 140, the sintered metal 130, and the first porous plate 120 may be held below the hot plate 150, and the “first mold 100 into which the slurry SL is filled” may be pressed against the first porous plate 120. That is, the arrangement shown in FIG. 4 may be turned upside down (inverted). This allows the solvent which vaporized to be evaporated (diffused) upwardly in a vertical direction. Therefore, the solvent whose specific gravity is small can be easily evaporated (diffused), so that the air holes are unlikely to be generated in the slurry SL.

Decreasing the pressure in the fine pores of the first porous plate 120 by driving the vacuum pump is optionally performed. Thus, the sintered metal 130 and the casing 140 may be replaced with a simple base. Further, heating the first porous plate 120 by the hot plate 150 is also optionally performed. Thus, the hot plate 150 may be omitted. Furthermore, the first mold 100 is pressed against the first porous plate 120 with the appropriate force when the first mold 100 is placed so as to oppose to the first porous plate 120 in the present example. However, during “decreasing the pressure in the fine pores of the first porous plate 120 by driving the vacuum pump and heating the first porous plate 120 by the hot plate 150” after that, no force may be applied to the first mold 100, or an appropriate force may be applied to the first mold 100 so that a density of the first porous plate 120 does not change locally.

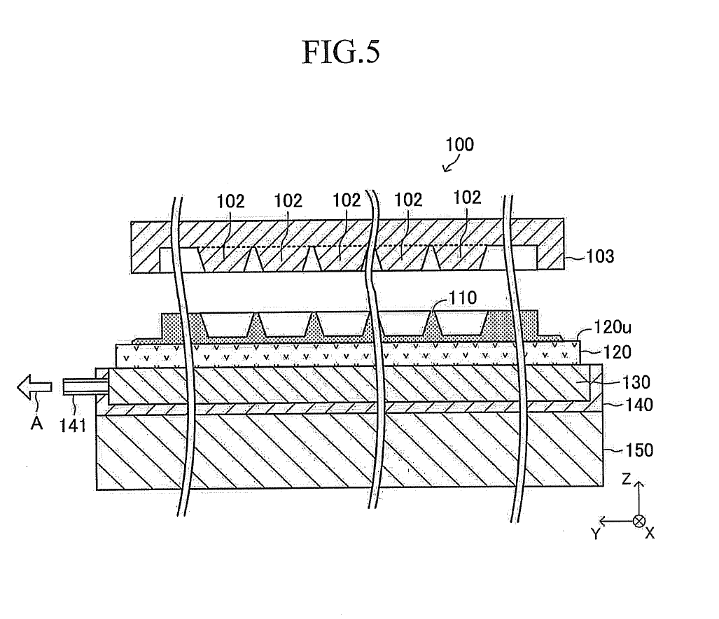

Thereafter, when the slurry SL has dried, and therefore, “the first compact-after-dried 110” has been formed, “the first mold 100, the first porous plate 120, and the first compact-after-dried 110” start to be cooled. Then, as shown in FIG. 5, the first mold 100 is released (removed) from “the first porous plate 120 and the first compact-after-dried 110”. That is, a demolding step is performed.

In this demolding step, it is preferable that the vacuum pump be driven so as to decrease the pressure in the sintered metal 130. This allows the sintered metal 130 to hold the first porous plate 120 stably, when the first mold 100 is removed (during demolding). As a result, it is possible to prevent the first porous plate 120 from being lifted up, and thus, a deformation of the first porous plate 120 and a deformation of the first compact-after-dried 110 (i.e., breakage of the pattern) can be avoided. It should be noted that the demolding step may not be performed at this stage, as described later. That is, the first compact-after-dried 110 may be kept (maintained) in the first mold 100.

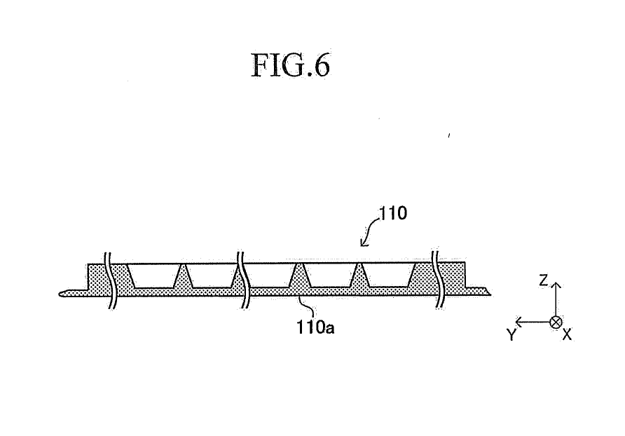

Subsequently, the first compact 110 is separated from the first porous plate 120. As a result, the first compact 110 shown in FIG. 6 is obtained.

As described above, the first compact forming step is a step for forming the first-compact-after-dried 110 by placing the first porous plate 120 and the first mold 100 in such a manner that they oppose (face) to each other while the slurry SL is maintained (or kept, held) between “the flat surface 102u of the first porous plate 120 and the molding surface of the first mold 100”, and drying the slurry SL through having the solvent included in the slurry SL permeate into the fine pores of the first porous plate 120.

### (Second Mold Preparing Step)

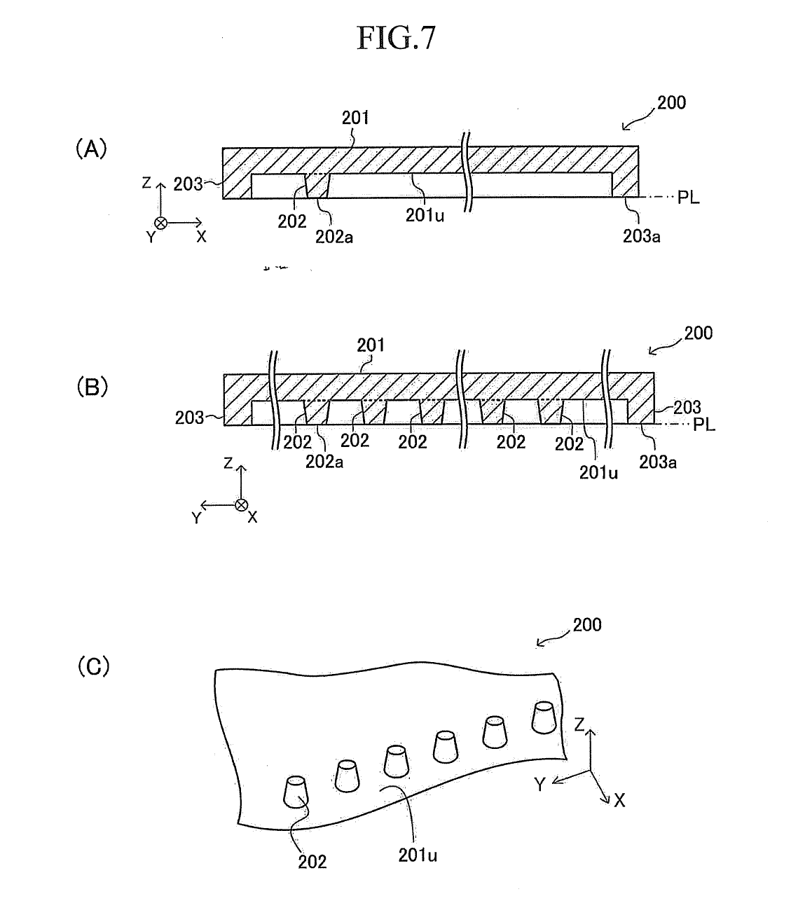

A second mold (a pressing mold, a stamper) 200 shown in (A) to (C) of FIG. 7 is prepared. The (A) of FIG. 7 is a cross-sectional view of the second mold 200 cut by a plane (X-Z plane) along a longitudinal direction (the X-axis direction) of the second mold 200. The (B) of FIG. 7 is a cross-sectional view of the second mold 200 cut by a plane (Y-Z plane) along a shorter side (Y-axis direction) of the second mold 200 at a “predetermined position in the side of the X-axis negative direction with respect to a central portion in the X-axis direction of the second mold 200”. The (C) of FIG. 7 is a partial perspective view of the second mold 200. The second mold 200 comprises a second base portion 201, second convexity portions 202, and a second frame portion 203.

The second base portion 201 is a substantially flat plate. Therefore, the second base portion 201 comprises at least one flat (plain) surface 201u.

The second convexity portions 202 stand (are held upright, or erect) from the flat surface 201u. The second convexity portions 202 have the substantially same shape as a shape defined by the nozzle sections 21b. That is, each of the second convexity portions 202 has a circular truncated cone shape. Each of the second convexity portions 202 is provided at each of the planar positions, the planar position being a position at which each of the nozzle sections 21b is to be formed. In other words, the second convexity portions 202 are a convexity portion including convexities having the substantially same shape as the shape of the nozzle sections 21b.

The second frame portion 203 stands (is held upright, or erects) from the flat surface 201u at an entire outer circumference of the second base portion 201. A shape defined by inner side surfaces of the second frame portion 203 is the substantially same as the shape defined by the outer circumference of the head body 20. A top surface 203a of the second frame portion 203 and a top surface 202a of each of the second convexity portions 202 exist on a single plane PL parallel to the second surface 201u.

A molding surface of the second mold 200 is composed of a portion (surface) of the flat surface 201u of the second base portion 201 where “the second convexity portions 202 and the second frame section 203” do not exist, surfaces of the second convexity portions 202, and the inner side surfaces of the second frame portion 203. As described above, it is preferable that the molding surface of the second mold 200 be coated with a mold release agent and/or the DLC, etc.

### (Second Porous Plate Preparing Step)

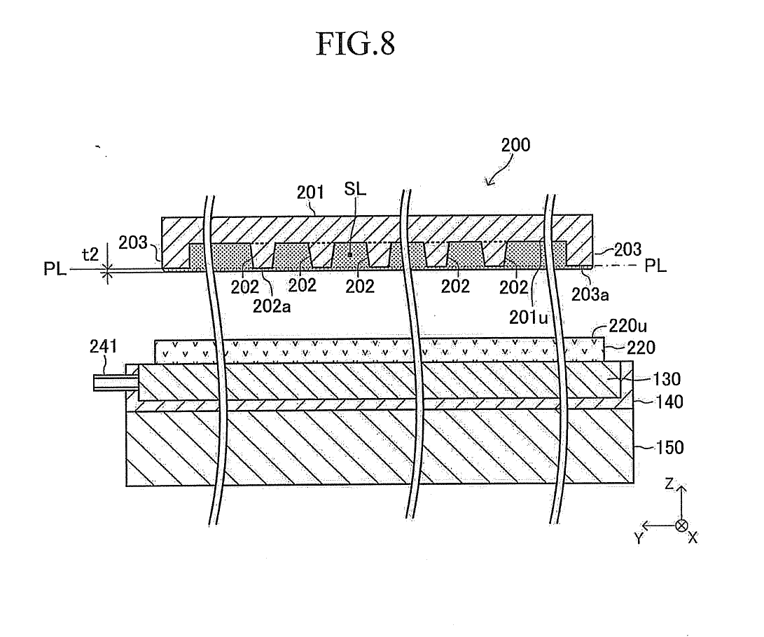

Similarly to the first porous plate preparing step, a second porous plate 220 through which gases can pass is prepared (refer to FIG. 8). The second porous plate 220 is a plate which is akin to the first porous plate 120. At least one surface 220u of surfaces of the second porous plate 220 (in actuality, both surfaces) is flat (plain).

### (Second Compact Forming Step)

As shown in FIG. 8, the slurry SL is filled into an inside of the second frame portion 203 of the second mold 200. The slurry SL is filled by applying. This step is also referred to as a “second slurry filling (or applying) step”. The slurry SL may be filled by any of appropriate methods other than applying, similarly to the first slurry filling step. Further, in order to improve a filling rate of the slurry, ultrasonic vibration may be applied to the second mold 200, or air bubbles remaining in the second mold 200 may be removed by a vacuum deaeration, when filling the slurry SL into the inside of the second frame portion 203. Further, the slurry SL may be filled into the second mold 200 by impressing (pushing) the second mold 200 onto (against) a plate prepared separately while holding (maintaining) the slurry SL between the second mold 200 and the plate. The plate may be a PET film or the like to which a mold release treatment has been applied in order to avoid a transfer of the slurry SL to the plate (that is, in such a manner that the slurry filled in the second mold 200 SL does not remain on the plate when the second mold 200 is released/separated from the plate).

In this second slurry filling step, the slurry SL is filled into the second mold 200 in an amount more than necessary (i.e., an excessive amount of slurry SL is filled). This is because, a pressure (filling pressure) of the slurry SL while filling the slurry SL is increased (enhanced) to thereby improve the filling rate of the slurry SL. This is also because it is necessary to take into consideration shrinkage of the slurry SL when it is being dried. As a result, as shown in FIG. 8, the slurry SL is filled into the second mold 200 in such a manner that a surface of the slurry SL exists outside of “the top surface 203a of the second frame portion 203 and the top surface 202a of each of the second convexity portions 202 (that is, the plane PL)” (see, a distance t2 shown in FIG. 8).

Meanwhile, as shown in FIG. 8, the second porous plate 220 is placed on an upper surface of a “porous sintered metal 130”. The sintered metal 130 is set (held) in a casing 140. A communicating pipe 141 for suction is inserted at and through a side portion of the casing 140. The communicating pipe 141 for suction is connected to a vacuum pump which is not shown. The casing 140 is placed on a hot plate 150.

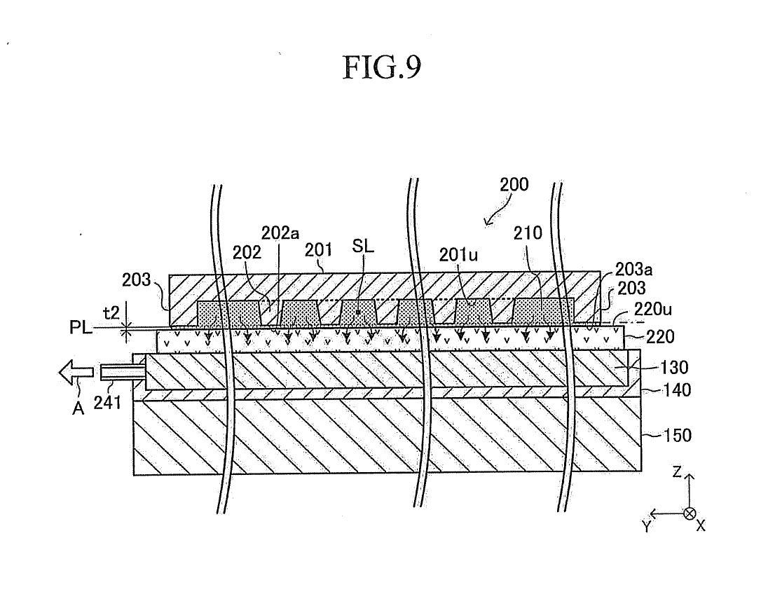

Subsequently, as shown in FIG. 9, the second porous plate 220 and the second mold 200 are set (placed) in such a manner that they are opposite (oppose, face) to each other while the slurry SL is maintained (or kept, held) between “the flat surface 220u of the second porous plate 220 and the molding surface of the second mold 200”.

Consequently, as shown by arrows in FIG. 9, the solvent included in “the slurry SL kept in the second mold 200” permeates into the fine pores in the vicinity of the flat surface 220u of the second porous plate 220 (contact surface between the slurry SL and the second porous plate 220) by capillarity, and vaporizes (is evaporated). As a result, the slurry SL is dried.

Further, in this step, the aforementioned vacuum pump is driven. Driving the vacuum pump allows gases existing in the second porous plate 220 to be discharged (refer to white frame arrow A). Therefore, a pressure in the second porous plate 220 becomes lower than the atmospheric pressure (e.g., lower than the atmospheric pressure by 80 kPa). Thus, the solvent included in the slurry SL is sucked into the fine pores of the second porous plate 220 (especially, the pores in the vicinity of the surface of the second porous plate 220) (or, permeates into the fine pores and is dried) efficiently. In this case as well, a degree of vacuum (the pressure in the second porous plate 220) is preferably 0 to −100 kPa, and more preferably −80 to −100 kPa.

It should be noted that it is more preferable that the sintered metal 130 and the second porous plate 220 be sealed up by covering “the exposed surface of the sintered metal 130 and the exposed surface of the second porous plate 220” with a gas tight film or the like, when the pressure in the fine pores of the second porous plate 220 is lowered by driving the vacuum pump. The exposed surface of the sintered metal 130 is a portion of the surface of the sintered metal 130 which is not covered by “the casing 140 and the second porous plate 220”. The exposed surface of the second porous plate 220 is a portion composed of the side surfaces of the second porous plate 220 and a portion of the flat surface (upper surface) 220u of the second porous plate 220 which is not covered by the second mold 200. If “the exposed surface of the sintered metal 130 and the exposed surface of the second porous plate 220” are not sealed up, the degree of vacuum of the second porous plate 220 decreases, and therefore, an efficiency in evaporation of the solvent becomes lowered. Further, a negative pressure is generated at portions from which the solvent of the slurry SL was evaporated, and therefore, air is introduced into the portions. As a result, air holes may be generated in the slurry SL in the vicinity of the second porous plate 220. In contrast, as described above, when “the exposed surface of the sintered metal 130 and the exposed surface of the second porous plate 220” are sealed up, the generation of such air holes can be prevented.

Furthermore, in this step, the hot plate 150 is energized. Therefore, a temperature of the second porous plate 220 increases, and thereby the solvent which has permeated into the fine pores of the second porous plate 220 can be easily evaporated (or diffused). As a result, the slurry SL is dried and becomes solidified, so that a second compact-after-dried 210 (second compact 210 which has been dried) is formed between “the second mold 200 and the second porous plate 220”.

It should be noted that, in this step, the hot plate 150 may be placed at an uppermost position, the casing 140, the sintered metal 130, and the second porous plate 220 may be held below the hot plate 150, and the “second mold 200 into which the slurry SL is filled” may be pressed against the second porous plate 220. That is, the arrangement shown in FIG. 9 may be turned upside down (inverted). This allows the solvent which vaporized to be evaporated (diffused) upwardly in a vertical direction. Therefore, the solvent whose specific gravity is small can be easily evaporated (diffused), so that the air holes are unlikely to be generated in the slurry SL.

Decreasing the pressure in the second porous plate 220 by driving the vacuum pump is optionally performed. Thus, the sintered metal 130 and the casing 140 may be replaced with a simple base. Further, heating the second porous plate 220 by the hot plate 150 is also optionally performed. Thus, the hot plate 150 may be omitted. Furthermore, the second mold 200 is pressed against the second porous plate 220 with the appropriate force when the second mold 200 is placed so as to oppose to the second porous plate 220 in the present example. However, during “decreasing the pressure in the fine pores of the second porous plate 220 by driving the vacuum pump and heating the second porous plate 220 by the hot plate 150” after that, no force may be applied to the second mold 200, or an appropriate force may be applied to the second mold 200 so that a density of the second porous plate 220 does not change locally.

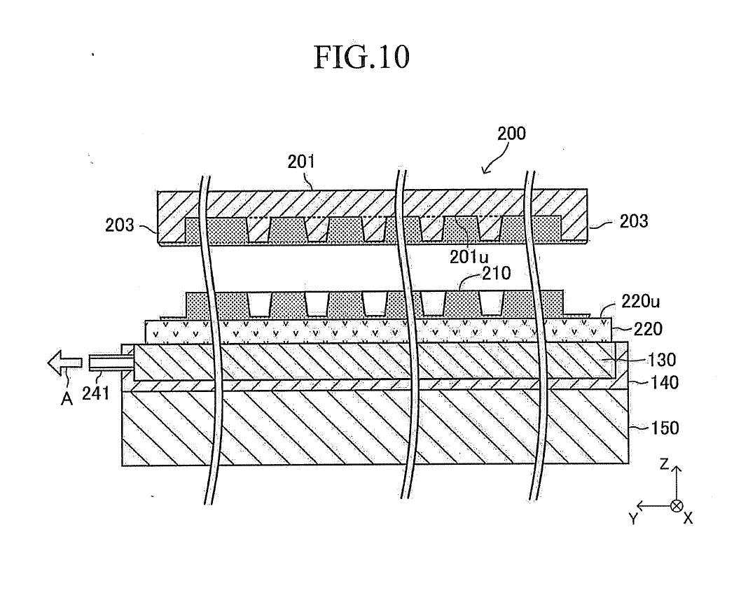

Thereafter, when the slurry SL has dried, and therefore, “the second compact-after-dried 210” has been formed, “the second mold 200, the second porous plate 220, and the second compact-after-dried 210” start to be cooled. Then, as shown in FIG. 10, the second mold 200 is released (removed) from “the second porous plate 220 and the second compact-after-dried 210”. That is, a demolding step is performed.

In this demolding step, it is preferable that the vacuum pump be driven so as to decrease the pressure in the sintered metal 130. This allows the sintered metal 130 to hold the second porous plate 220 stably, when the second mold 200 is removed (during demolding). As a result, it is possible to prevent the second porous plate 220 from being lifted up, and thus, a deformation of the second porous plate 220 and a deformation of the second compact-after-dried 210 (i.e., breakage of the pattern) can be avoided. It should be noted that the demolding step may not be performed at this stage, as described later. That is, the second compact-after-dried 210 may be kept (maintained) in the second mold 200.

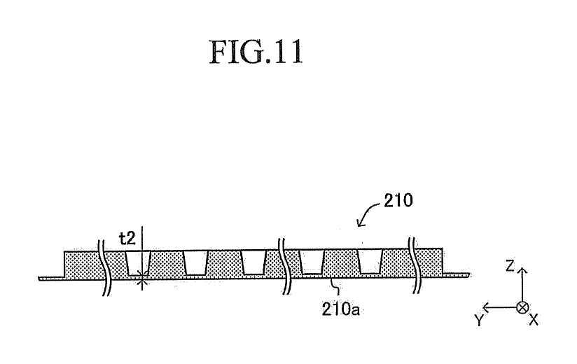

Subsequently, the second compact 210 is separated from the second porous plate 220. As a result, the second compact 210 shown in FIG. 11 is obtained.

As described above, the second compact forming step is a step for forming the second-compact-after-dried 210 by placing the second porous plate 220 and the second mold 200 in such a manner that they oppose (face) to each other while the slurry SL is maintained (or kept, held) between “the flat surface 220u of the second porous plate 220 and the molding surface of the second mold 200”, and drying the slurry SL through having the solvent included in the slurry SL permeate into the fine pores of the second porous plate 220.

### (Head-Body-Before-Fired Forming Step)

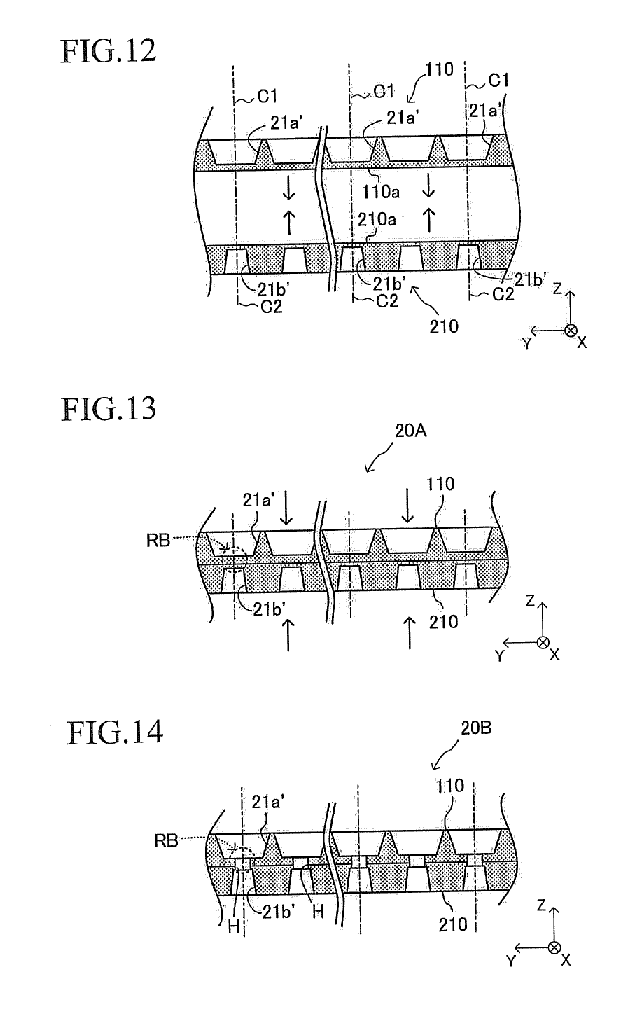

Subsequently, as shown in FIG. 12, the second compact 210 is turned upside down (inverted), and then, the first compact 110 and the second compact 210 are joined. That is, the first compact 110 and the second compact 210 are joined by a thermal compression bonding in such a manner that a flat surface portion 110a of the first compact 110 and a flat surface portion 210a of the second compact 210 are parallel to and contact with each other. Before this thermal compression bonding, an adhesive paste is applied to the flat surface portion 110a of the first compact 110 and the flat surface portion 210a of the second compact 210, or a resin is applied to them by spraying. Also, before this thermal compression bonding, an adhesive resin film may be disposed between the flat surface portion 110a of the first compact 110 and the flat surface portion 210a of the second compact 210. The flat surface portion 110a of the first compact 110 is a portion formed by the flat surface 120u of the first porous plate 120. The flat surface portion 210a of the second compact 210 is formed by the flat surface 220u of the second porous plate 220.

Further, when the first compact 110 and the second compact 210 are joined, the first compact 110 and the second compact 210 are joined in such a manner that a “central axis C1 of a bottom surface of the groove section 21a′ formed by the first convexity portion 102 of the first mold 100” coincides with a “central axis C2 of the concave portion 21b′ formed by the second convexity portion 202 of the second mold 200”, and in such a manner that a position of the concave portion 21b′ relative to a position of the groove section 21a coincides with a “position of the nozzle section 21b relative to the pressure chamber 21 in the droplet discharge head body 20”.

It should be noted that, in a state in which the first compact 110 after dried is maintained in the first-mold 100 and the second compact 210 after dried is maintained in the second mold 200, the first compact 110 and the second compact 210 may be joined by the thermal compression bonding in such a manner that the flat surface portion 110a of the first compact 110 and the flat surface portion 210a of the second compact 210 are parallel to and contact with each other, and thereafter, the first mold 100 and the second mold 200 may be released (separated). It is preferable that the demolding step be performed after the first compact 110 and the second compact 210 are joined in this manner, because the pattern is unlikely to be broken, and the pressure bonding force can become sufficiently large.

Consequently, a “droplet discharge head body-before removal-of-the-remnant 20A” shown in FIG. 13 is formed. As shown in a circle with a dashed line in FIG. 13, the droplet discharge head body 20A has the remnant (remaining portion) RB. The remnant RB includes: a portion (first remnant) formed of the slurry SL which existed between the top surfaces 102a of the convexity portions 102 of the first mold 100 and the flat surface 120u of the first porous plate 120; a portion (second remnant) formed of the slurry SL which existed between the top surfaces 202a of the convexity portions 202 of the second mold 200 and the flat surface 220u of the second porous plate 220; and “the adhesion (bonding) layer formed of “the adhesive paste, the resin, the adhesive resin film, or the like” applied or provided between the flat surface portion 110a and the flat surface portion 210a.

Subsequently, a part of or a whole of the remnant RB is removed (eliminated) by a laser processing so that the groove section 21a′ and the concave portion 21b′ are communicated with each other. That is, as shown in FIG. 14, through holes H are formed in the remnant RB. Accordingly, each of nozzle sections composed of the concave portion 21b′ and the through hole H is formed. In this manner, a “droplet discharge head body-before-fired 20B” shown in FIG. 14 is made.

### (Firing Step)

In the meantime, a ceramic green sheet to be the vibration plate 30 and a ceramic green sheet to be the liquid storage chamber cover member 40 are prepared, separately. Further, a through hole to be the liquid supply through hole 40a is formed in the ceramic green sheet to be the liquid storage chamber cover member 40 at an appropriate position. Thereafter, the ceramic green sheet to be the vibration plate 30 and the ceramic green sheet to be the liquid storage chamber cover member 40 are layered on the droplet discharge head body-before-fired 20B while aligning them in a planar direction. Subsequently, these are joined by a thermal compression bonding, and the thermal compression bonded layered body is fired after it is degreased. As a result, the head body 20 (fired layered body) having the vibration plate 30 and the liquid storage chamber cover member 40 is completed.

### (Piezoelectric Element Forming Step)

Thereafter, according to a well-known method, piezoelectric elements are formed at predetermined positions. For example, the head body 20 and a piezoelectric element including a fired piezoelectric membrane are joined. Subsequently, a mask is formed on the piezoelectric element, and fine particles (abrasive grains) are injected to the mask to thereby remove (eliminate) the piezoelectric element on which the mask does not exist. That is, so-called “blast processing” is used to form the piezoelectric elements 50 (refer to, for example, Japanese Patent No. 3340043). By means of these processes, a “fired droplet discharge head body without the discharge hole tip portion forming member 60” are completed. It should be noted that piezoelectric elements which have not been fired may be formed on the vibration plate 30 at predetermined positions, and thereafter, the piezoelectric elements may be fired.

### (Other Member Joining Step)

Further, the discharge hole tip portion forming member 60 is separately prepared. The discharge hole tip portion forming member 60 is made of a metal (e.g., SUS) in the present example. A plurality (in the present example, nine) of through holes to be the liquid discharge holes 60a are formed in the discharge hole tip portion forming member 60. Lastly, the discharge hole tip portion forming member 60 is joined to a lower surface of the “fired droplet discharge head body without the discharge hole tip portion forming member 60”, using an adhesive bond. That is, the member (discharge hole tip portion forming member) 60 having through holes (liquid discharge holes) 60a is joined onto a surface (lower surface of the droplet discharge head body 20) of the fired droplet discharge head body in the side of the nozzles in such a manner that the each of the through holes 60a communicates with each of the base side nozzle sections 21b (the concave portion 21b′ and the through hole H). At this time, the “droplet discharge head body without the discharge hole tip portion forming member 60” and the “discharge hole tip portion forming member 60” are aligned in such a manner that the central axis of each of the liquid discharge holes 60a coincides with the central axis of each of the base side nozzle sections 21b (i.e., these are coaxially). Through these steps, the droplet discharge head 10 is completed.

As described above, according to the first manufacturing method, the first compact 110 is made by forming and drying the slurry SL using the first mold 100, and the second compact 210 is made by forming and drying the slurry SL using the second mold 200. Thereafter, the first compact 110 and the second compact 210 are joined to make the layered body-before-fired of the droplet discharge head body 20. Accordingly, the first manufacturing method has the following advantages.

### (First Advantage)

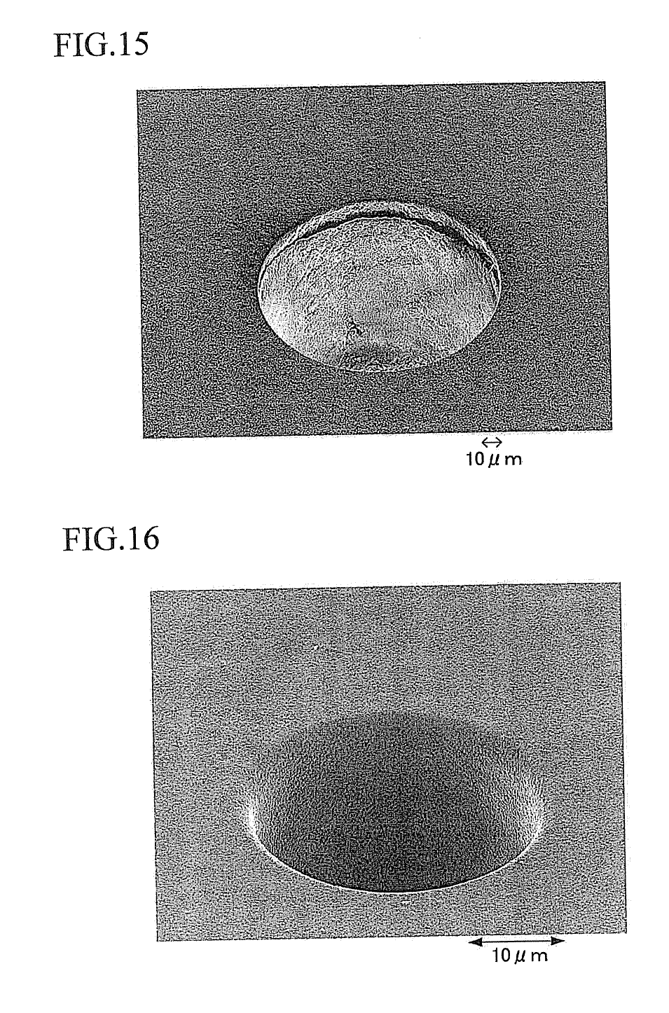

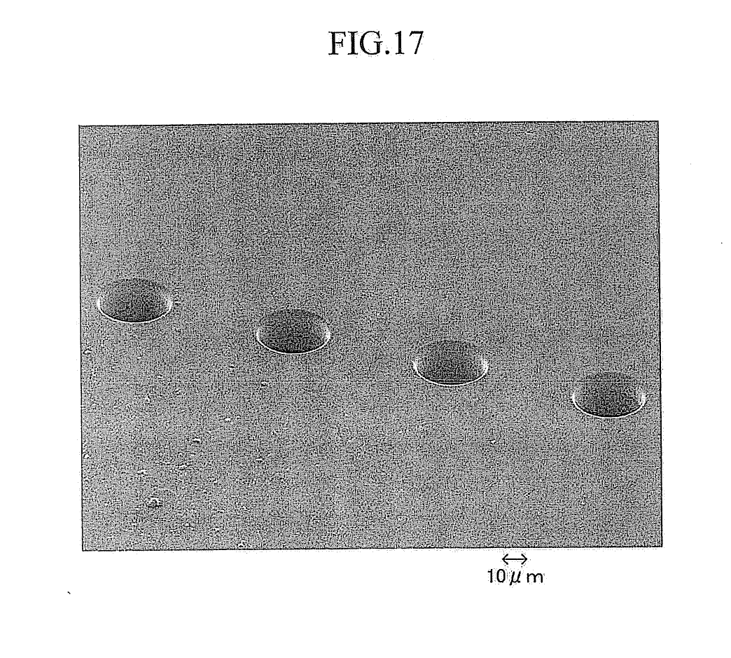

When the nozzle section is formed by a conventional punching process using a mold and a die, a fracture surface becomes rough, and burrs, cracks, or the like are generated, as shown in the photograph in FIG. 15. In contrast, according to the first manufacturing method, the nozzle section 21b (concave portion 21b′) is formed by forming the slurry using the mold. Accordingly, as shown in the photographs in FIGS. 16 and 17, the surface of the nozzle section is smooth and has no burrs or the like. As a result, the droplet discharge head capable of stably discharging droplets can be provided. Further, according to the first manufacturing method, the pressure chambers 21 are made by forming the slurry using the mold. Therefore, the droplet discharge head 10 having an excellent shape accuracy can be manufactured, even when the pressure chambers 21 are miniaturized, and the distance between the pressure chambers 21 adjacent to each other is short.

### (Second Advantage)

An amount of and a thickness of the slurry to be dried in a single forming step can be made smaller (reduced), as compared to a case in which a single mold is used to dry and form the slurry in order to make the layered body-before-fired of the droplet discharge head body 20. Consequently, a time required to “dry and form” the slurry SL can be shorten. Therefore, the droplet discharge head 10 can be manufactured efficiently.

### (Third Advantage)

Further, when the layered body-before-fired of the droplet discharge head body 20 is made using a single mold, a contact area between “the compact (layered body-before-fired) and the mold” becomes large, and the thickness of the compact becomes large. Thus, the likelihood that the compact is deformed during demolding is increased. In contrast, in the first manufacturing method, the first compact 110 and the second compact 210 are made separately, and therefore, the likelihood that the first compact 110 is deformed during demolding can be decreased, and the likelihood that second compact 210 is deformed during demolding can be decreased.

### (Fourth Advantage)

In addition, when the layered body-before-fired of the droplet discharge head body 20 is made using a single mold, an amount of slurry to be filled is large and a shape of a molding surface of the mold becomes complicated. Therefore, the likelihood of involving air bubbles in the slurry SL while the slurry SL is being filled into the mold is high. The first manufacturing method can decrease such a likelihood.

### (Fifth Advantage)

Furthermore, in the first manufacturing method, the second compact 210 is turned upside down (inverted), and then, the first compact 110 and the second compact 210 are joined. Accordingly, the surface onto which the discharge hole tip portion forming member 60 is joined is the surface formed by the flat surface 201u of the second mold 200, and thus is extremely flat/smooth. Consequently, the discharge hole tip portion forming member 60 can be solidly/strongly joined.

It should be noted that, in the first manufacturing method (and a second manufacturing method described later), as long as the slurry preparing step, the first mold preparing step, and the first porous plate preparing step are performed before the first compact forming step, these steps can be performed in any order. Similarly, as long as the slurry preparing step, the second mold preparing step, and the second porous plate preparing step are performed before the second compact forming step, these steps can be performed in any order. Further, as long as the first compact forming step and the second compact forming step are performed before the head-body-before-fired forming step, these steps can be performed in any order.

### Second Embodiment

Next, a “method for manufacturing a droplet discharge head” according to a second embodiment of the present invention will be described. Hereinafter, the manufacturing method according to the second embodiment is also referred to as a second manufacturing method.

The second manufacturing method is different from the first manufacturing method in that the head-body-before-fired forming step is differs from the head-body-before-fired forming step of the first manufacturing method. Hereinafter, each of steps is described sequentially.

### (Slurry Preparing Step)

The slurry SL is prepared according to a step which is the same as the slurry preparing step of the first manufacturing method.

### (First Mold Preparing Step)

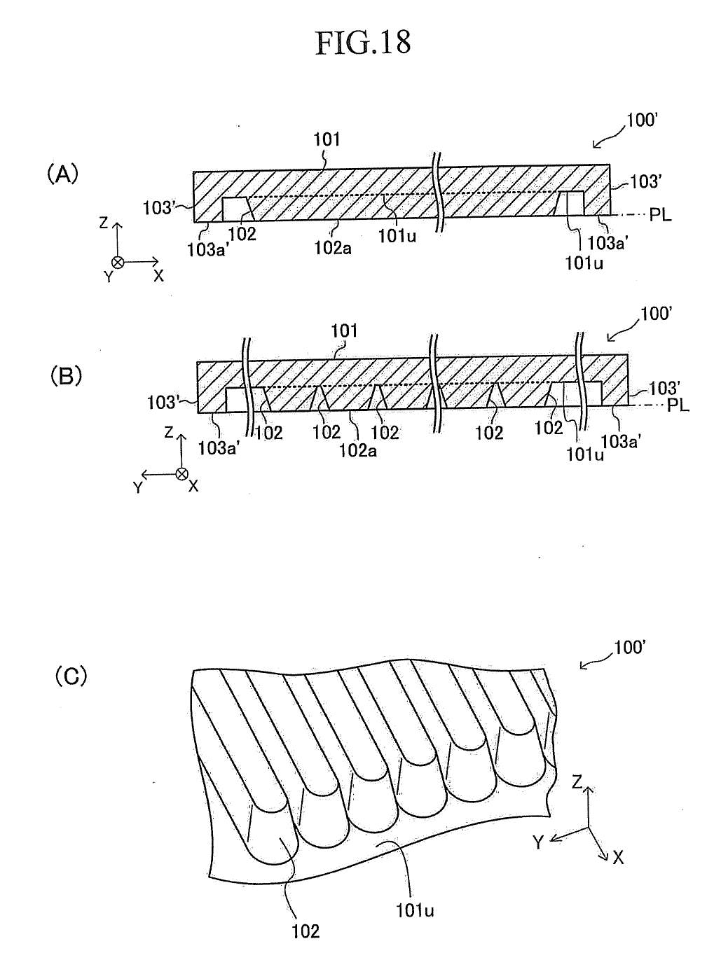

A first mold (a pressing mold, a stamper) 100′ shown in (A) to (C) of FIG. 18 is prepared. The (A) of FIG. 18 is a cross-sectional view of the first mold 100′ cut by a plane (X-Z plane) along a longitudinal direction (the X-axis direction) of the first mold 100′. The (B) of FIG. 18 is a cross-sectional view of the first mold 100′ cut by a plane (Y-Z plane) along a shorter side (Y-axis direction) of the first mold 100′ at a “predetermined position in the side of the X-axis negative direction with respect to a central portion in the X-axis direction of the first mold 100′”. The (C) of FIG. 18 is a partial perspective view of the first mold 100′.

The first mold 100′ is the same type as the first mold 100, and comprises the first base portion 101, the first convexity portions 102, and a first frame portion 103′.

The first frame portion 103′ stands (is held upright, or erects) from the flat surface 101u at an entire outer circumference of the first base portion 101. A shape defined by inner side surfaces of the first frame portion 103′ is the substantially same as the shape defined by the outer circumference of the head body 20. A distance between the flat surface 101u and a top surface 103a′ of the first frame portion 103′ (i.e., height of the first frame portion 103′) is the same as the distance between the flat surface 101u and the top surface 102 of each of the first convexity portions 102 (i.e., height of the first convexity portion 102). That is, the top surface 103a′ and the top surfaces 102a exist on a single plane PL parallel to the flat surface 101u. As described above, it is also preferable that the molding surface of the first mold 100′ be coated with the mold release agent.

### (First Porous Plate Preparing Step)

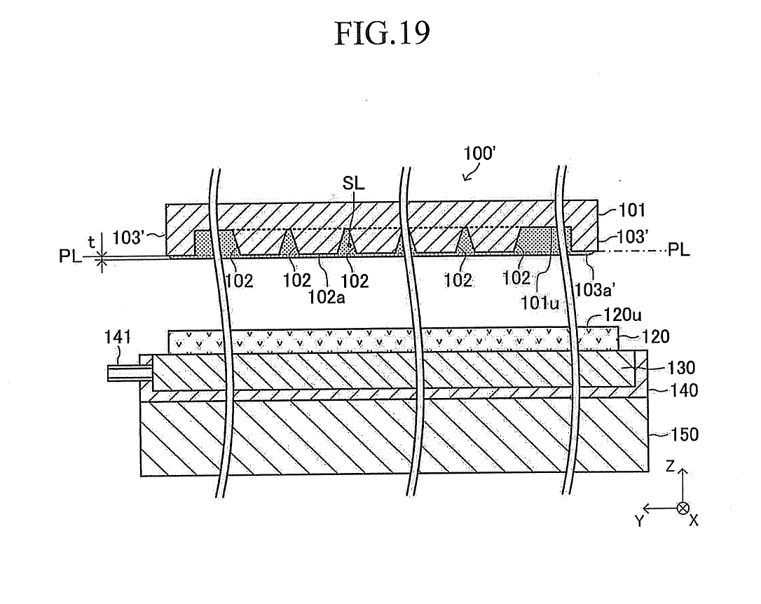

Similarly to the first porous plate preparing step of the first manufacturing method, a first porous plate 120 through which gases can pass is prepared (refer to FIG. 19).

### (First Compact Forming Step)

As shown in FIG. 19, similarly to the first compact forming step of the first manufacturing method, the slurry SL is filled into an inside of the first frame portion 103′ of the first mold 100′. At this time, the slurry SL is filled into the first mold 100′ in an amount more than necessary. This is because, a pressure (filling pressure) of the slurry SL while filling the slurry SL is increased (enhanced) to thereby improve the filling rate of the slurry SL. This is also because it is necessary to take into consideration shrinkage of the slurry SL when it is being dried. As a result, as shown in FIG. 19, the slurry SL is filled into the first mold 100′ in such a manner that a surface of the slurry SL exists outside of “the top surface 103a′ of the first frame portion 103′ (see, a distance t shown in FIG. 19).

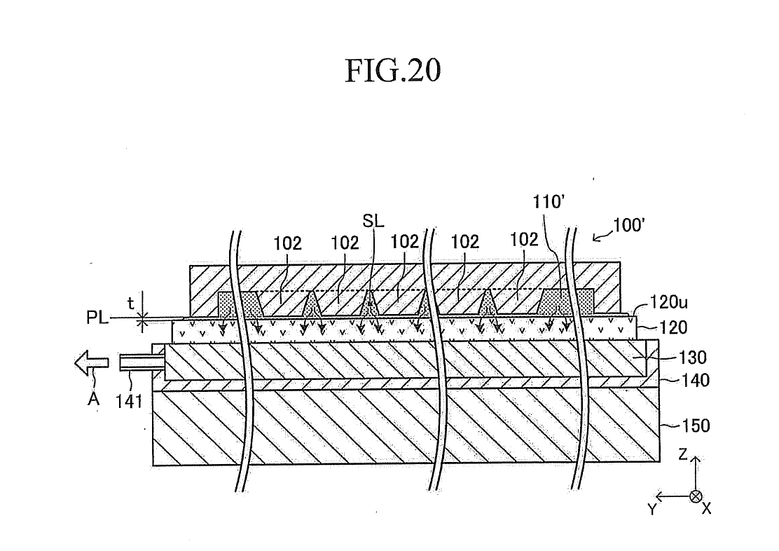

Subsequently, as shown in FIG. 20, similarly to the first compact forming step of the first manufacturing method, the first porous plate 120 and the first mold 100′ are set (placed) in such a manner that they are opposite (oppose, face) to each other while the slurry SL is maintained (or kept, held) between “the flat surface 120u of the first porous plate 120 and the molding surface of the first mold 100′”. That is, the first mold 100′ into which the slurry SL is filled is placed on the flat surface 120u of the first porous plate 120. At this time, the first mold 100′ is pressed against the first porous plate 120 with an appropriate force.

Consequently, as shown by arrows in FIG. 20, the solvent included in “the slurry SL kept in the first mold 100” permeates into the fine pores in the vicinity of the flat surface 120u of the first porous plate, 120 (contact surface between the slurry SL and the first porous plate 120) by capillarity, and vaporizes (is evaporated). As a result, the slurry SL is dried. In this case, decreasing the pressure in the fine pores of the first porous plate 120 by driving the vacuum pump is also optionally performed. Further, heating the first porous plate 120 by the hot plate 150 is also optionally performed. It should be noted that it is more preferable that the sintered metal 130 and the first porous plate 120 be sealed up by covering “the exposed surface of the sintered metal 130 and the exposed surface of the first porous plate 120” with the gas tight film or the like, when the pressure in the fine pores of the first porous plate 120 is lowered by driving the vacuum pump.

Further, in this step, the hot plate 150 may be placed at an uppermost position, the casing 140, the sintered metal 130, and the first porous plate 120 may be held below the hot plate 150, and the “first mold 100′ into which the slurry SL is filled” may be pressed against the first porous plate 120. That is, the arrangement shown in FIG. 20 may be turned upside down (inverted). This allows the solvent which vaporized to be evaporated (diffused) upwardly in a vertical direction. Therefore, the solvent whose specific gravity is small can be easily evaporated (diffused), so that the air holes are unlikely to be generated in the slurry SL.

In the present example, the first mold 100′ is pressed against the first porous plate 120 with the appropriate force when the first mold 100′ is placed so as to oppose to the first porous plate 120. However, during “decreasing the pressure in the fine pores of the first porous plate 120 by driving the vacuum pump and heating the first porous plate 120 by the hot plate 150” after that, no force may be applied to the first mold 100′, or an appropriate force may be applied to the first mold 100′ so that a density of the first porous plate 120 does not change locally.

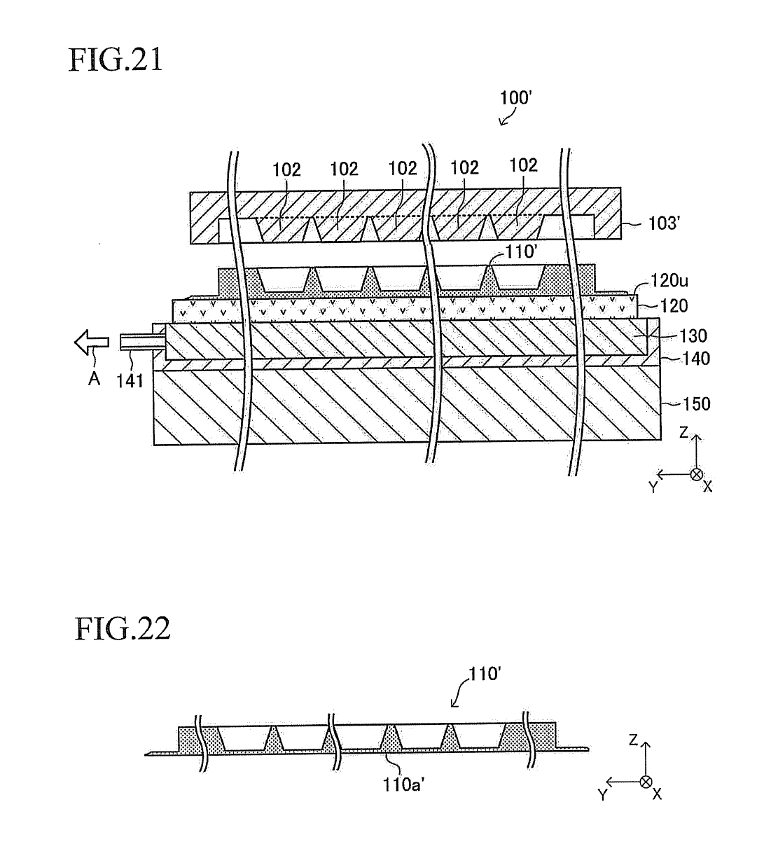

Thereafter, when the slurry SL has dried, and therefore, “the first compact-after-dried 110” has been formed, “the first mold 100′, the first porous plate 120, and the first compact-after-dried 110” start to be cooled. Then, as shown in FIG. 21, the first mold 100′ is released (removed) from “the first porous plate 120 and first compact-after-dried 110”. That is, a demolding step is performed. During this demolding step, the vacuum pump may be driven. It should be noted that the demolding step may not be performed at this stage. That is, the first compact-after-dried 110′ may be kept (maintained) in the first mold 100′.

Subsequently, the first compact 110′ is separated from the first porous plate 120. As a result, the first compact 110′ shown in FIG. 22 is obtained.

As described above, the first compact forming step is a step for forming the first-compact-after-dried 110′ by placing the first porous plate 120 and the first mold 100′ in such a manner that they oppose (face) to each other while the slurry SL is maintained (or kept, held) between “the flat surface 120u of the first porous plate 120 and the molding surface of the first mold 100′”, and drying the slurry SL through having the solvent included in the slurry SL permeate into the fine pores of the first porous plate 120.

### (Second Mold Preparing Step, Second Porous Plate Preparing Step, and Second Compact Forming Step)

“A second mold preparing step, a second porous plate preparing step, and a second compact forming step” of the second manufacturing method are the same as ones of the first manufacturing method, respectively. As a result, the second compact 210 shown in FIG. Ills obtained.

### (Head-Body-Before-Fired Forming Step)

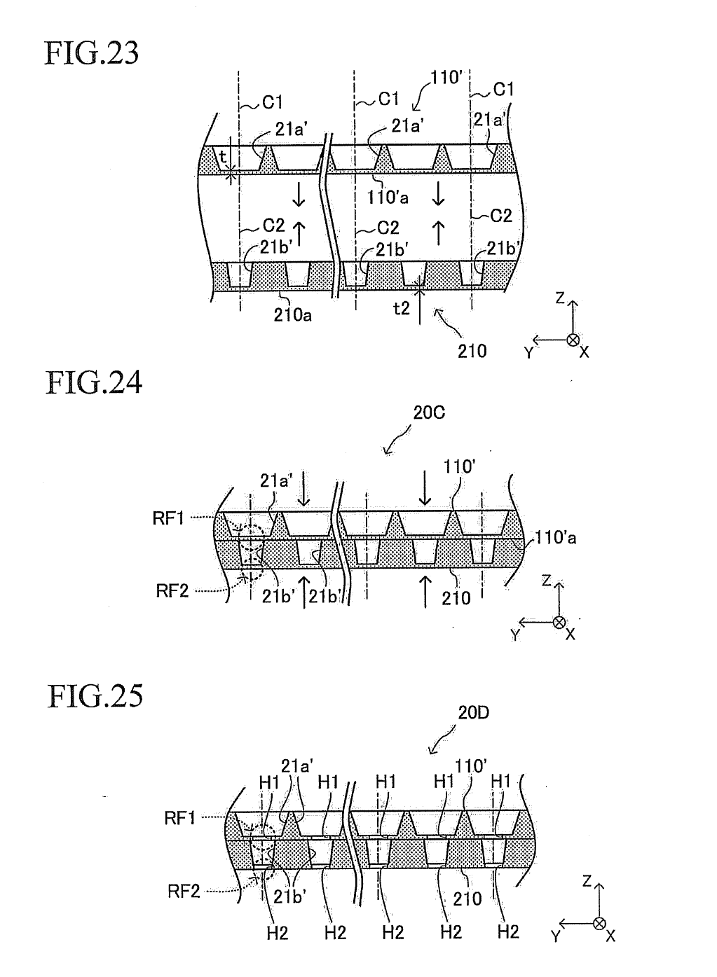

In the first manufacturing step, the second compact 210 is turned upside down (inverted), and then, the first compact 110 and the second compact 210 are joined. In contrast, in the second manufacturing method, as shown in FIG. 23, the first compact 110′ and the second compact 210 are joined without turning upside down (inverting) the second compact 210.

That is, the first compact 110′ and the second compact 210 are joined by a thermal compression bonding in such a manner that a flat surface portion 110′a of the first compact 110′ and the flat surface portion 210a of the second compact 210 are parallel to each other. Before this thermal compression bonding, an adhesive paste is applied to the flat surface portion 110′a of the first compact 110′ and an upper surface of the second compact 210 formed by the flat surface 201u of the second mold 200, or a resin is applied to them by spraying. Also, before this thermal compression bonding, an adhesive resin film may be disposed between the flat surface portion 110′a of the first compact 110′ and the upper surface of the second compact 210 formed by the flat surface 201u of the second mold 200.

Further, when the first compact 110′ and the second compact 210 are joined, the first compact 110′ and the second compact 210 are joined in such a manner that a “central axis C1 of a bottom surface of each of the groove sections 21a′ formed by the first convexity portions 102 of the first mold 100” coincides with a “central axis C2 of each of the concave portions 21b′ formed by the second convexity portions 202 of the second mold 200”, and in such a manner that a position of the concave portion 21b′ relative to a position of the groove section 21a′ coincides with a “position of the nozzle section 21b relative to the pressure chamber 21 in the droplet discharge head body 20”.

Consequently, a “droplet discharge head body-before removal-of-the-remnant-membrane 20C” shown in FIG. 24 is formed. As shown in two circles with dashed lines in FIG. 24, the droplet discharge head body 20C has a remnant membrane RF1 and a remnant membrane RF2. The remnant membrane RF1 is composed of the slurry SL which remained between the top surfaces 102a of the convexity portions 102 of the first mold 100′ and the flat surface 120u of the first porous plate 120, and the adhesion (bonding) layer formed of “the adhesive paste, the resin, the adhesive resin film, or the like” applied or provided between the flat surface portion 110a′ of the first compact 110′ and a top surface of the second compact 210. The remnant membrane RF2 is composed of the slurry which remained between top surfaces 202a of the convexity portions 202 of the second mold 200 and the flat surface 220u of the second porous plate 220.

Subsequently, the remnant membrane RF1 is removed (eliminated) by a laser processing so that each of the groove sections 21a′ and each of the concave portions 21b′ are communicated with each other. That is, as shown in FIG. 25, through holes H1 are formed in the remnant membrane RB1. Further, the remnant membrane RF2 is removed (eliminated) by a laser processing. That is, as shown in FIG. 25, through holes H2 are formed in the remnant membrane RF2. Accordingly, each of a nozzle sections composed of the groove portion 21a′, the concave portion 21b′, the through hole H1 and the through hole H2 is formed. In this manner, a “droplet discharge head body-before-fired 20D” shown in FIG. 25 is made. It should be noted that the remnant membrane RF2 is removed (eliminated) by a polishing processing.

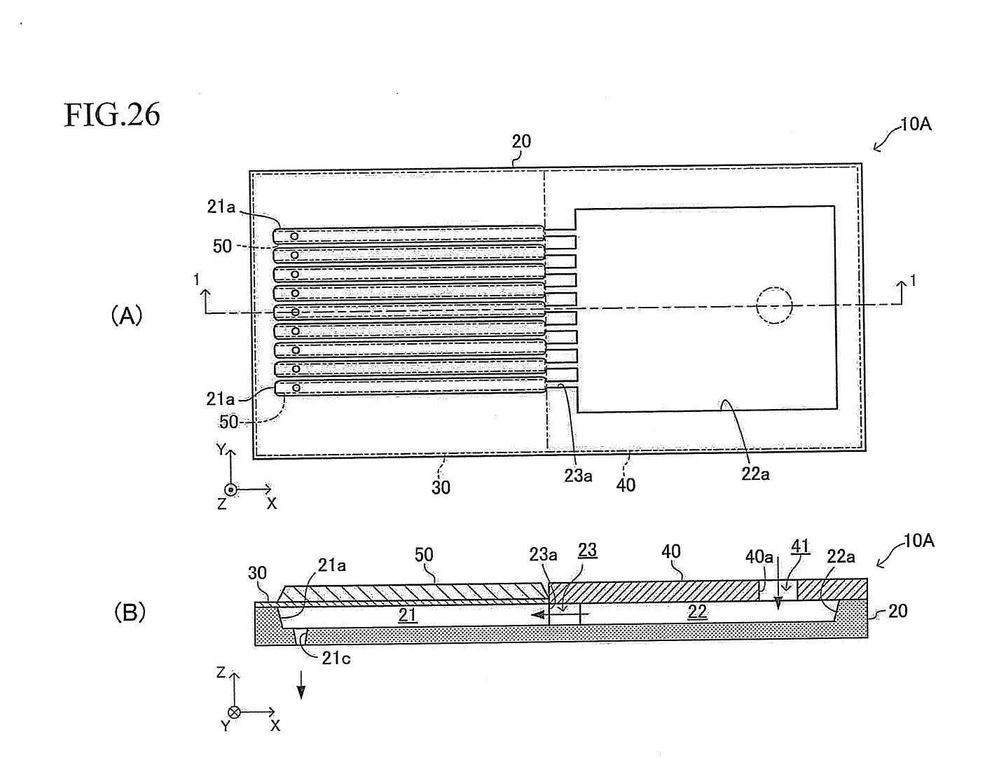

Thereafter, a droplet discharge head 10A shown in FIG. 26 is completed through “a firing step and a piezoelectric element forming step” similar to ones of the first manufacturing method, respectively. The droplet discharge head 10A is the same as the droplet discharge head 10 shown in FIG. 1, except that the discharge hole tip portion forming member 60 is omitted from the droplet discharge head 10, and a shape of the “nozzle section 21c formed of the concave portion 21b′ and the through hole H2. The second manufacturing method has the first to fourth advantages that the first manufacturing method includes. In addition, the firing step may be performed before removing the remnant membrane RF2, and the remnant membrane RF2 may be removed by a precision polishing after the firing step. This enables to precisely adjust a diameter of the tip portion (portion of the opening, a droplet discharge opening) of the nozzle section 21b, and therefore, the nozzle plate (discharge hole tip portion forming member) which is another member (e.g., SUS, or the like) may not need to be used. As a result, it is likely to greatly decrease a manufacturing time.

### Third Embodiment

Next, a “method for manufacturing a droplet discharge head” according to a third embodiment of the present invention will be described. Hereinafter, the manufacturing method according to the third embodiment is also referred to as a third manufacturing method. In the third manufacturing method, only one (a single) mold is used to make a layered body-before-fired for the droplet discharge head body 20. Each of steps will be described.

### (Slurry Preparing Step)

The slurry SL is prepared according to a step which is the same as the slurry preparing step of the first manufacturing method.

### (Mold Preparing Step)

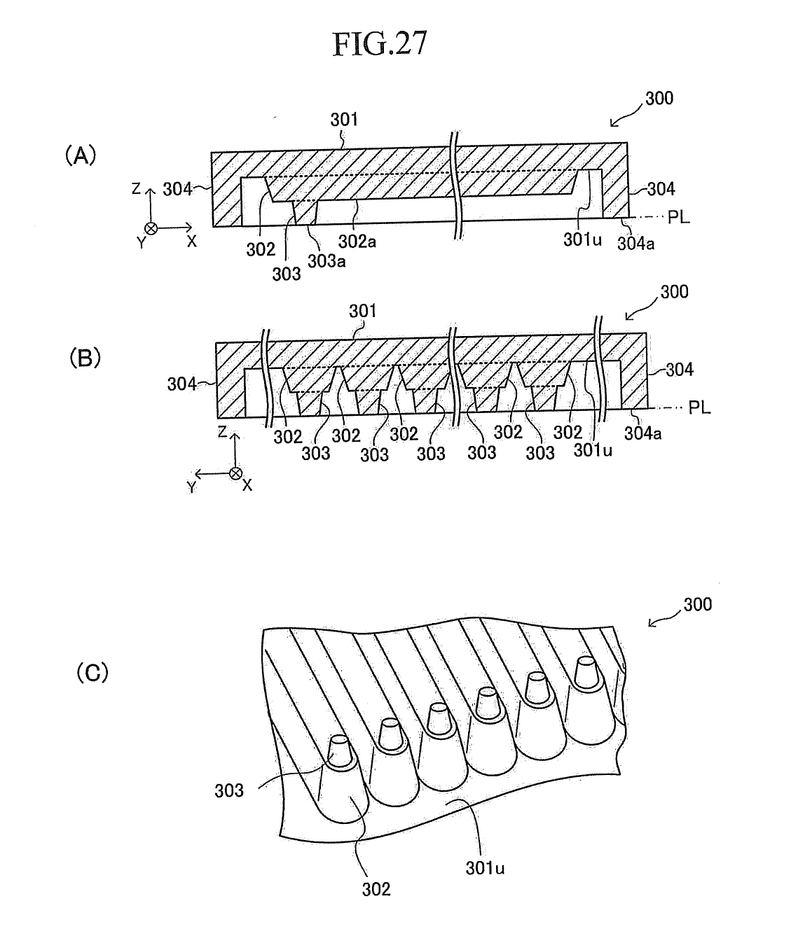

A mold (a pressing mold, a stamper) 300 shown in (A) to (C) of FIG. 27 is prepared. This mold is also referred to as a third mold 300. The (A) of FIG. 27 is a cross-sectional view of the third mold 300 cut by a plane (X-Z plane) along a longitudinal direction (the X-axis direction) of the third mold 300. The (B) of FIG. 27 is a cross-sectional view of the third mold 300 cut by a plane (Y-Z plane) along a shorter side (Y-axis direction) of the third mold 300 at a “predetermined position in the side of the X-axis negative direction with respect to a central portion in the X-axis direction of the third mold 300”. The (C) of FIG. 27 is a partial perspective view of the third mold 300. The third mold 300 comprises a base portion 301, convexity portions for forming pressure chambers 302, convexity portions for forming nozzle sections 303, and a frame portion 304.

The base portion 301 is a substantially flat plate. Therefore, the base portion 301 comprises at least one flat (plain) surface 301u.

The convexity portions for forming pressure chambers 302 stand (are held upright, or erect) from the flat surface 301u. The convexity portions for forming pressure chambers 302 have the substantially same shape as a shape defined by “a plurality of the groove sections 21a, the concave section 22a, and a plurality of the groove sections 23a” described above. That is, the convexity portions for forming pressure chambers 302 have the substantially same shape as a shape defined by “a plurality of the pressure chambers 21, the liquid storage chamber 22, and a plurality of the liquid flow holes 23”. In other words, the convexity portions for forming pressure chambers 302 are a convexity portion including convexities, each having the substantially same shape as the shape of each of the pressure chambers 21 that are arranged parallel to each other.

Each of the convexity portions for forming nozzle sections 303 stands (is held upright, or erects) from a top surface 302a of each of the convexity portions for forming pressure chambers 302. Each of the convexity portions for forming nozzle sections 303 has the substantially same shape as the shape of each of the nozzle sections 21c shown in FIG. 26. That is, each of the convexity portions for forming nozzle sections 303 has a circular truncated cone shape. In other words, the third mold 300 has a convexity portion including convexities having the substantially same shape as a shape of a “liquid chamber including a plurality of the pressure chambers 21, and a plurality of the nozzle sections 21c”.

The frame portion 304 stands (is held upright, or erects) from the flat surface 301u at an entire outer circumference of the base portion 301. A shape defined by inner side surfaces of the frame portion 304 is the substantially same as the shape defined by the outer circumference of the head body 20 shown in FIG. 26. A top surface 304a of the frame portion 304 and each of top surfaces 303a of each of the convexity portions for forming nozzle sections 303 exist on a single plane PL parallel to the flat surface 301u.

A molding surface of the mold 300 is composed of a portion (surface) of the flat surface 301u of the base portion 301 where “the convexity portions for forming pressure chambers 302 and the convexity portions for forming nozzle sections 303” do not exist; a portion (surface) of the convexity portions for forming pressure chambers 302 where the convexity portions for forming nozzle sections 303 do not exist, surfaces of the convexity portions for forming nozzle sections 303, and the inner side surfaces of the frame portion 304. As described above, it is preferable that the molding surface of the mold 300 be coated with a mold release agent.

### (Porous Plate Preparing Step)

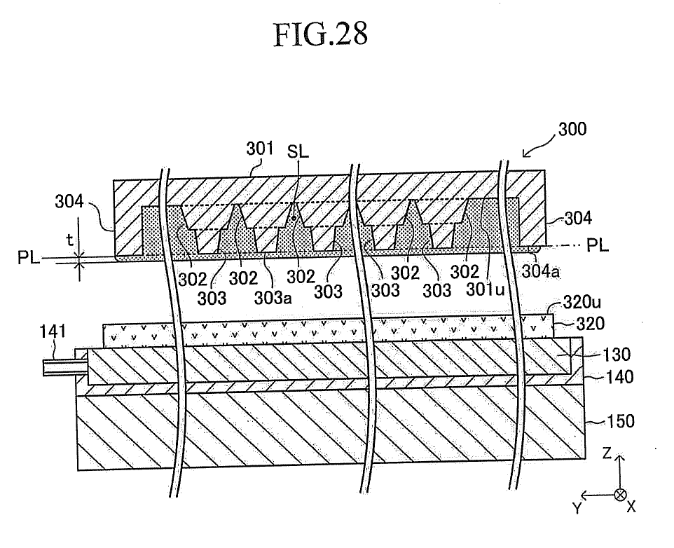

Similarly to the first porous plate preparing step, a porous plate 320 through which gases can pass is prepared (refer to FIG. 28). The porous plate 320 is a plate which is akin to the first porous plate 120. At least one surface 320u of surfaces of the porous plate 320 (in actuality, both surfaces) are flat (plain).

### (Compact Forming Step)

As shown in FIG. 28, the slurry SL is filled into an inside of the frame portion 304 of the mold 300. The slurry SL is filled by applying. This step is also referred to as a “slurry filling (or applying) step”. The slurry SL may be filled by any of appropriate methods other than applying, similarly to the first slurry filling step. Further, in order to improve a filling rate of the slurry, ultrasonic vibration may be applied to the mold 300, or air bubbles remaining in the mold 300 may be removed by a vacuum deaeration, when filling the slurry SL into the inside of the frame portion 304. Further, the slurry SL may be filled into the mold 300 by impressing (pushing) the mold 300 onto (against) a plate which is prepared separately while holding (maintaining) the slurry SL between the mold 300 and the plate. The plate may be a PET film or the like to which a mold release treatment has been applied in order to avoid a transfer of the slurry SL to the plate (that is, in such a manner that the slurry filled in the mold 300 does not remain on the plate when the mold 300 is released/separated from the plate).

In this slurry filling step, the slurry SL is filled into the mold 300 in an amount more than necessary (i.e., an excessive amount of slurry SL is filled). This is because, a pressure (filling pressure) of the slurry SL while filling the slurry SL is increased (enhanced) to thereby improve the filling rate of the slurry SL. This is also because it is necessary to take into consideration shrinkage of the slurry SL when it is being dried. As a result, as shown in FIG. 28, the slurry SL is filled into the mold 300 in such a manner that a surface of the slurry SL exists outside of “the top surface 304a of the frame portion 304 and the top surfaces 303a of each of the convexity portions for forming nozzle sections 303 (i.e., a plane PL)” of the mold 300 (see, a distance t shown in FIG. 28).

Meanwhile, as shown in FIG. 28, the porous plate 320 is placed on an “upper surface of a porous sintered metal 130”. The sintered metal 130 is set (held) in a casing 140. A communicating pipe 141 for suction is inserted at and through a side portion of the casing 140. The communicating pipe 141 for suction is connected to a vacuum pump which is not shown. The casing 140 is placed on the hot plate 150.

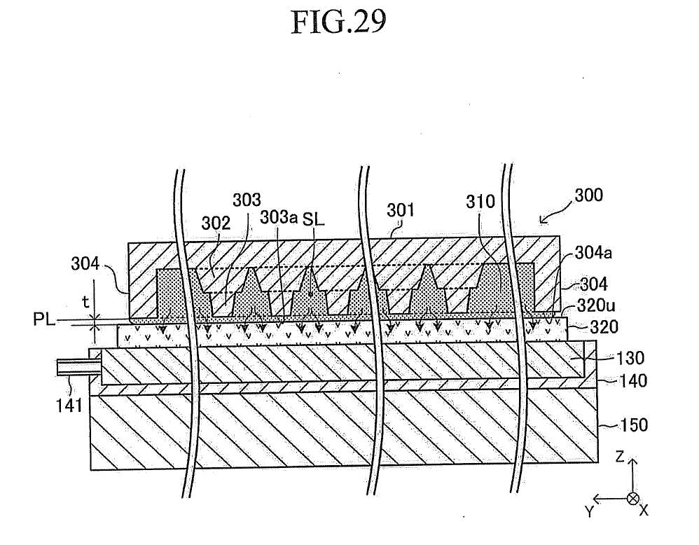

Subsequently, as shown in FIG. 29, the porous plate 320 and the mold 300 are set (placed) in such a manner that they are opposite (oppose, face) to each other while the slurry SL is maintained (or kept, held) between “the flat surface 320u of the porous plate 320 and the molding surface of the mold 300”.

Consequently, as shown by arrows in FIG. 29, the solvent included in “the slurry SL kept in the mold 300” permeates into the fine pores in the vicinity of the flat surface 320u of the porous plate 320 (contact surface between the slurry SL and the porous plate 320) by capillarity, and vaporizes (is evaporated). As a result, the slurry SL is dried.

Further, in this step, the aforementioned vacuum pump is driven. Driving the vacuum pump allows gases existing in the porous plate 320 to be discharged (refer to white frame arrow A). Therefore, a pressure in the porous plate 320 becomes lower than the atmospheric pressure (e.g., lower than the atmospheric pressure by 80 kPa). Thus, the solvent included in the slurry SL is sucked into the fine pores of the porous plate 320 (especially, the fine pores in the vicinity of the surface of the porous plate 320) (or, permeates into the fine pores and is dried) efficiently. In this case as well, a degree of vacuum (the pressure in the porous plate 320) is preferably 0 to −100 kPa, and more preferably −80 to −100 kPa.

It should be noted that it is more preferable that the sintered metal 130 and the porous plate 320 be sealed up by covering “the exposed surface of the sintered metal 130 and the exposed surfaces of the porous plate 320” with a gas tight film or the like, when the pressure in the pores of the porous plate 320 is lowered by driving the vacuum pump.

Furthermore, in this step, the hot plate 150 is energized. Therefore, a temperature of the porous plate 320 increases, and thereby the solvent which has permeated into the fine pores of the porous plate 320 can be easily evaporated (or diffused). As a result, the slurry SL is dried and becomes solidified, so that a compact-after-dried 310 is formed between “the mold 300 and the porous plate 320”.

It should be noted that, in this step, the hot plate 150 may be placed at an uppermost position, the casing 140, the sintered metal 130, and the porous plate 320 may be held below the hot plate 150, and the “mold 100 into which the slurry SL is filled” may be pressed against the porous plate 320. This allows the solvent which vaporized to be evaporated (diffused) upwardly in a vertical direction. Therefore, the solvent whose specific gravity is small can be easily evaporated (diffused), so that the air holes are unlikely to be generated in the slurry SL.

Decreasing the pressure in the fine pores of the porous plate 320 by driving the vacuum pump is optionally performed. Thus, the sintered metal 130 and the casing 140 may be replaced with a simple base. Further, heating the porous plate 320 by the hot plate 150 is also optionally performed. Thus, the hot plate 150 may be omitted. Furthermore, the mold 300 is pressed against the porous plate 320 with the appropriate force when the mold 300 is placed so as to oppose to the porous plate 320 in the present example. However, during “decreasing the pressure in the fine pores of the porous plate 320 by driving the vacuum pump and heating the porous plate 320 by the hot plate 150” after that, no force may be applied to the mold 300, or an appropriate force may be applied to the mold 300 so that a density of the porous plate 320 does not change locally.

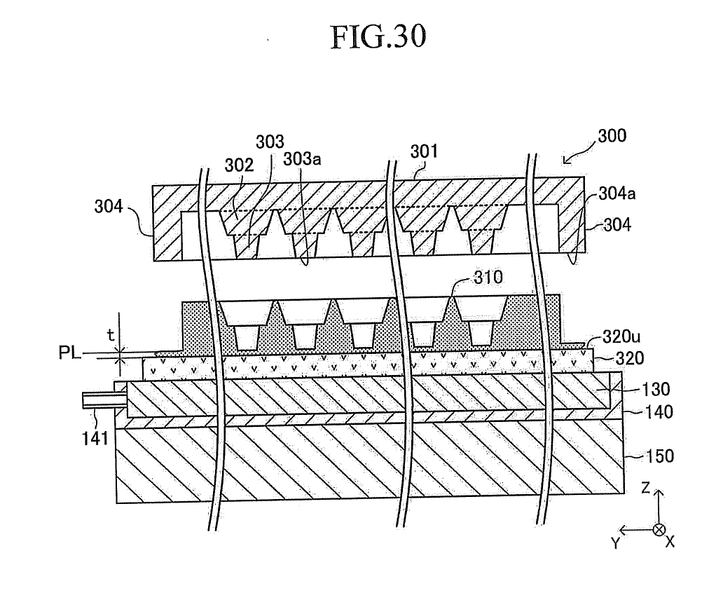

Thereafter, when the slurry SL has dried, and therefore, “the compact-after-dried 310” has been formed, “the mold 300, the porous plate 320, and the compact-after-dried 310” start to be cooled. Then, as shown in FIG. 30, the mold 300 is released (removed) from “the porous plate 320 and the compact-after-dried 310”. That is, a demolding step is performed.

In this demolding step, it is preferable that the vacuum pump be driven so as to decrease the pressure in the sintered metal 130. This allows the sintered metal 130 to hold the porous plate 320 stably, when the mold 300 is removed (during demolding). As a result, it is possible to prevent the porous plate 320 from being lifted up, and thus, a deformation of the porous plate 320 and a deformation of the compact-after-dried 310 (i.e., breakage of the pattern) can be avoided.

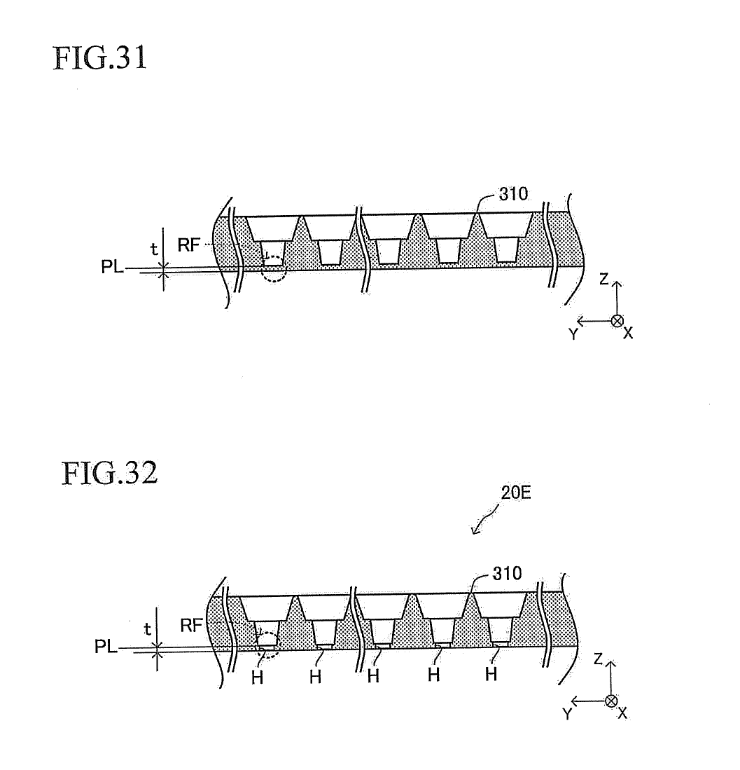

Subsequently, the compact 310 is separated from the porous plate 320. As a result, the compact 310 shown in FIG. 31 is obtained.

It should be noted that, before the demolding step is performed, the porous plate 320 may be released from the compact 310, and thereafter, a surface of the compact 310 from which the porous plate 320 was released may be fixed to a heat reactive adhesive film or by suction, and so on. Thereafter, the demolding step may be performed under such a state to thereby release the mold 300 from the compact 310 to obtain the compact 310 shown in FIG. 31. This allows a pattern of the compact 310 to be fixed by the mold 300 when the porous plate 320 is released, the likelihood of the deformation of or the breakage of the pattern can be decreased.

The thus formed compact 310 has a remnant membrane RF shown in a circle with a dashed line in FIG. 31. The remnant membrane RF is formed of the slurry SL which remained between the top surfaces 303a of each of the convexity portions for forming nozzle sections 303 of the mold 300 and the flat surface 320u of the porous plate 320.

As described above, the compact forming step is a step for forming the compact-after-dried 310 by placing the porous plate 320 and the mold 300 in such a manner that they oppose (face) to each other while the slurry SL is maintained (or kept, held) between “the flat surface 320u of the porous plate 320 and the molding surface of the mold 300”, and drying the slurry SL through having the solvent included in the slurry SL permeate into the fine pores of the porous plate 320.

### (Head-Body-Before-Fired Forming Step)

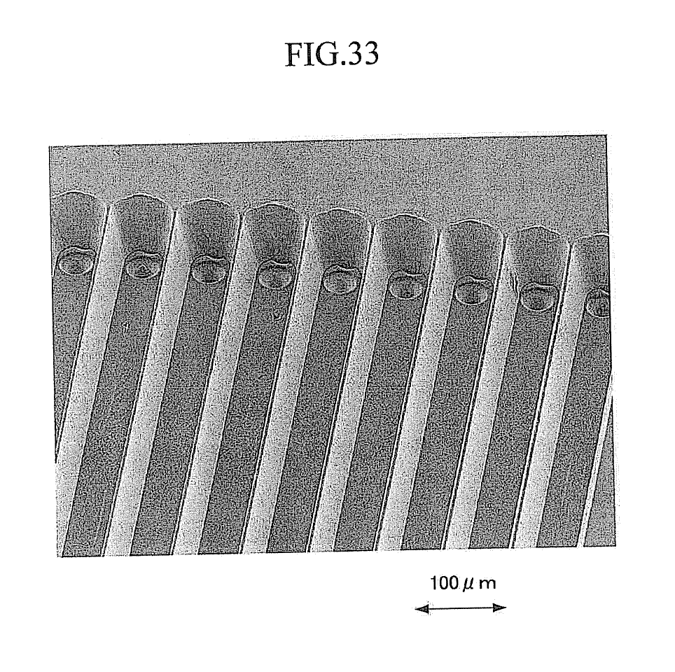

Subsequently, the remnant membrane RF is removed (eliminated) by a laser processing. That is, as shown in FIG. 32, through holes H are formed in the remnant membrane RF. As a result, the nozzle sections are formed. In this manner, a “head body-before-fired 20E” shown in FIG. 32 is made. FIG. 33 is a partially magnified photograph of the thus manufactured head body-before-fired 20E. It should be noted the remnant membrane RF may be remove by a polishing process.

### (Firing Step and Piezoelectric Element Forming Step)

Thereafter, similarly to the first manufacturing method, “the ceramic green sheet to be the vibration plate 30 and the ceramic green sheet to be the liquid storage chamber cover member 40” are layered on the head body-before-fired 20E while aligning them in a planar direction to obtain a layered body. Subsequently, the layered body is fired. Further, similarly to the first manufacturing method, piezoelectric elements are formed at predetermined positions according to the well-known method. In this manner, a droplet discharge head, which is similar to the droplet discharge head 10A shown in FIG. 26, is completed.

According to the third manufacturing method, the “compact-after-dried 310” is made by drying the slurry SL using the single mold 300 in the single compact forming step. Therefore, unlike the first and second manufacturing method, two of compacts-after-dried need not be joined. Thus, the processes can be simplified. Further, it is unnecessary to join two compacts by pressure bonding while aligning those two compacts, and therefore, the droplet discharge head having a desired shape can easily be manufactured.

It should be noted that as long as the slurry preparing step, the mold preparing step, and the porous plate preparing step are performed before the compact forming step, these steps can be performed in any order.

Further, in place of removing the remnant membrane RF (forming the through holes H) by the laser processing in the head-body-before-fired forming step, the obtained layered body may fired, and thereafter, the remnant membrane RF may be removed by a precision polishing. This enables to precisely adjust a diameter of the tip portion (portion of the opening, droplet discharge opening) of the nozzle section 21c, and therefore, the nozzle plate (discharge hole tip portion forming member) which is another member (e.g., SUS, or the like) may not need to be used. As a result, it is likely that the manufacturing steps are greatly reduced.

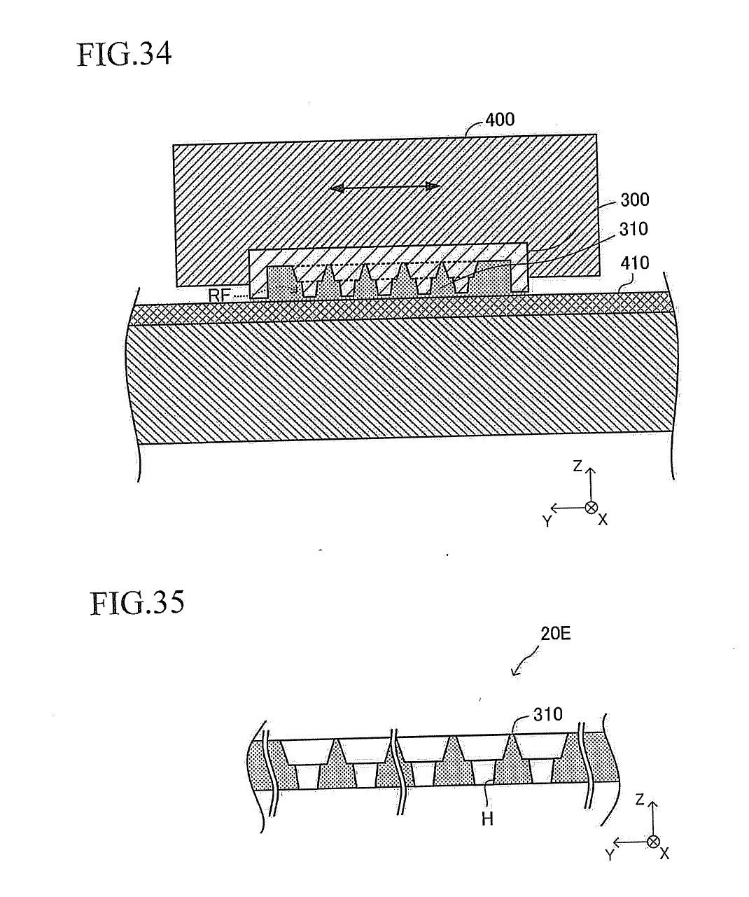

Further, in place of removing the remnant membrane RF (forming the through holes H) by the laser processing in the head-body-before-fired forming step, the remnant membrane RF may be removed (eliminated) by polishing as shown in FIG. 34, after the slurry SL is dried and solidified and therefore, the compact-after-dried 310 is formed between “the mold 300 and the porous plate 320” (refer to FIG. 29), and before the mold 300 is released from the compact-after-dried 310 (i.e., before demolding). That is, the polishing may be performed to form the through holes H (refer to FIG. 35) while the compact-after-dried 310 is maintained (held) in the mold 300.

More specifically, this polishing is performed as follows.

Firstly, when the compact-after-dried 310 is formed in the mold 300 as shown in FIG. 29, the compact-after-dried 310 is released/separated from the porous plate 320 while the compact-after-dried 310 is maintained in the mold 300.

Subsequently, as shown in FIG. 34, the mold 300 maintaining the compact-after-dried 310 in its inside is held at a back side of the mold 300 by a polishing retainer 400. Then, an exposed surface of the compact-after-dried 310 is impressed onto (pressed against) the polishing plate 410 while the polishing retainer 400 is reciprocated in a horizontal direction, to thereby perform the polishing. After the polishing is completed (i.e., the remnant membrane RF is removed), demolding is preformed. As a result, a “head body-before-fired 20E” shown in FIG. 35 is made.

Polishing the compact-after-dried 310 in a state in which the compact-after-dried 310 is maintained in the mold 300 (i.e., performing “a polishing process-before-demolding”) in this manner has advantages as follows.

### (Advantage 1)

If polishing is performed on a compact-after-fired, grinding sludge and/or abrasive grains may enter into the pressure chambers, and so on. Accordingly, removing (eliminating) step for those is necessary. In contrast, according to the method described above, the compact-after-dried 310 is polished in the state in which the compact-after-dried 310 is maintained in the mold 300, and therefore, grinding sludge and/or abrasive grains do not enter into the pressure chambers, and so on. Therefore, such a removing (eliminating) step is not necessary. Consequently, the manufacturing method as a whole can be simplified.

### (Advantage 2)

Since the polishing is performed with using the back side of the mold 300 (i.e., surface opposite to the molding surface) as a reference, a flatness of the surface to be polished (exposed surface of the compact-after-dried 310) is easily ensured.

### (Advantage 3)

Since the “compact-before-fired 310” has lower hardness compared to a fired body, a polishing rate can be increased. That is, the polishing can be completed within shorter time.

It should be noted that, when the “polishing process-before-demolding” is performed, a material having a high hardness is preferably used for the mold 300, or a DLC (diamond like carbon) treatment is preferably applied to surfaces of the mold 300.

As described above, each of the embodiments according to the present invention allows the droplet discharge head body to be formed by “drying the slurry in the mold”. Accordingly, the droplet discharge head having an excellent shape accuracy can be manufactured, even if the pressure chambers, and the like are miniaturized.

The present invention is not limited to the above embodiments, but may be modified as appropriate within the scope of the invention.

For example, in the first manufacturing method, before the first compact 110 and the second compact 210 are joined as shown in FIG. 12, each of the remnant membranes may be removed. That is, the remnant membrane of the first compact-after-dried 110 may be removed by polishing the exposed surface (portion which contacted with the flat surface 120u of the first porous plate 120) of the first compact-after-dried 110 in a state in which the first compact-after-dried 110 is maintained in the first mold 100, the remnant membrane of the second compact-after-dried 210 may be removed by polishing the exposed surface (portion which contacted with the flat surface 220u of the second porous plate 220) of the second compact-after-dried 210 in a state in which the second compact-after-dried 210 is maintained in the second mold 200, and thereafter, the first compact-after-dried 110 and the second compact-after-dried 210 may be joined together.

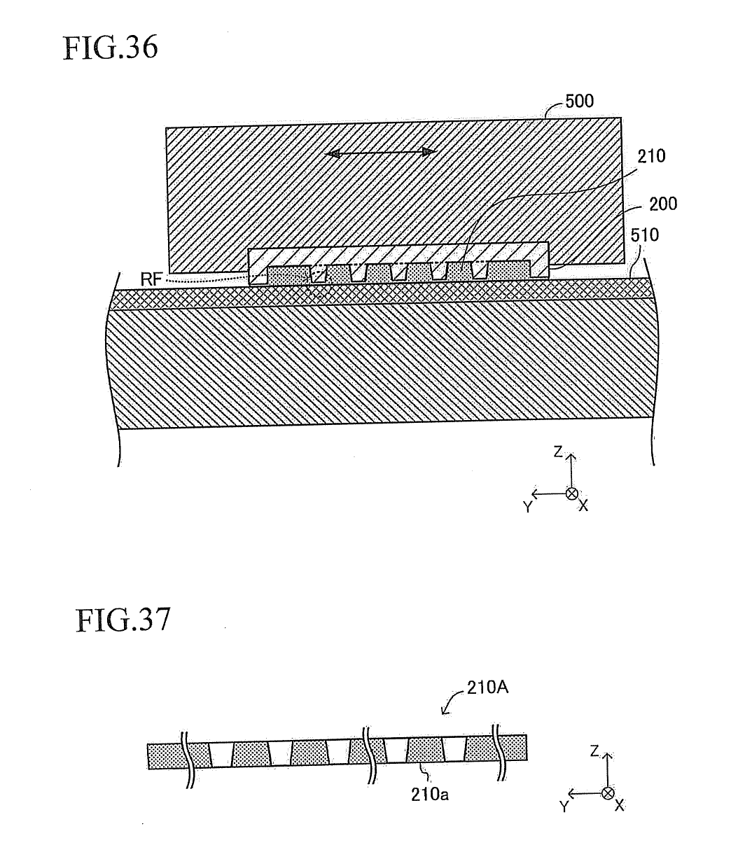

FIG. 36 shows an example of a concrete method for removing the remnant membrane RF of the second compact-after-dried 210 by polishing the exposed surface of the second compact-after-dried 210 in the state in which the second compact-after-dried 210 is maintained in the second mold 200.

More specifically, the polishing is performed in such a manner that the mold 200 maintaining the compact-after-dried 210 in its inside is held at a back side of the mold 200 by a polishing retainer 500, then, an exposed surface of the compact-after-dried 210 is impressed onto (pressed against) the polishing plate 510 while the polishing retainer 500 is reciprocated in a horizontal direction. After the polishing is completed (i.e., the remnant membrane RF is removed), demolding is preformed. As a result, a “head body-before-fired 20E” shown in FIG. 37 is made.

Polishing the compact-after-dried 210 (i.e., forming the through holes H2) in the state in which the compact-after-dried 210 is maintained in the mold 200 (i.e., performing “a polishing process-before-demolding”) in this manner has the same advantages as ones obtained when polishing the compact-after-dried 310 in the state in which the compact-after-dried 310 is maintained in the mold 300.

That is, briefly speaking, the polishing process-before-demolding has advantages described below.

### (Advantage 1)

Since the compact-after-dried 210 is polished in the state in which the compact-after-dried 210 is maintained in the mold 200, grinding sludge and/or abrasive grains do not enter into the concave portions 21b′ etc. formed by the second convexity portions 202. Therefore, a step for removing the grinding sludge and/or abrasive grains is not necessary.

### (Advantage 2)

Since the polishing is performed with using the back side of the mold 200 (surface opposite to the molding surface) as a reference, a flatness of the surface to be polished (exposed surface of the compact-after-dried 210) is easily ensured.

### (Advantage 3)

Since the “compact-before-fired 210” has lower hardness compared to a fired body, a polishing rate can be increased. That is, the polishing can be completed within shorter time.

It should be noted that, when the “polishing process-before-demolding” is performed, a material having a high hardness is preferably used for the mold 200, or a DLC (diamond like carbon) treatment is preferably applied to surfaces of the mold 200. In addition, according to a method similar to the method shown in FIG. 36, the remnant membrane of the first compact-after-dried 110 may be removed by polishing the exposed surface of the first compact-after-dried 110 in a state in which the first compact-after-dried 110 is maintained in the first mold 100.

Similarly, in the second manufacturing method, for example, before the first compact 110′ and the second compact 210 are joined as shown in FIG. 23, each of the remnant membranes may be removed. That is, the remnant membrane RF1 of the first compact-after-dried 110′ may be removed by polishing the exposed surface (portion which contacted with the flat surface 120u of the first porous plate 120) of the first compact-after-dried 110′ in a state in which the first compact-after-dried 110′ is maintained in the first mold 100′, the remnant membrane RF2 of the second compact-after-dried 210 may be removed by polishing the exposed surface (portion which contacted with the flat surface 220u of the second porous plate 220) of the second compact-after-dried 210 in a state in which the second compact-after-dried 210 is maintained in the second mold 200, and thereafter, the first compact (first compact 110A) from which the remnant membrane RF1 was removed and the second compact 210 (second compact 210A) from which the remnant membrane RF2 was removed may be joined together.

Also, in the second manufacturing method, the firing step may be performed before the remnant membrane RF2 shown in FIG. 24 is removed, and the remnant membrane RF may be removed by a “blast processing for injecting abrasive grains” after it is fired. The blast processing in this case may be a “special blast processing using elastic grains”, which is disclosed in, for example, Japanese Laid-Open publication 2006-159402. The blast processing is a method for injecting or projecting polishing agents K each of which includes “abrasive grains, each having small diameter, made of SiC, or the like” fixed to an “elastic base material having a relatively large diameter” to a “surface of an object to be processed” in (with) a direction different from a normal line of the surface of the object to be processed. It should be noted that a diameter Dk of the base material of the polishing agent K is preferably larger than a diameter of the nozzle section 21b′. In this case, the remnant membrane RF1 of the first compact-after-dried 110′ may be removed by “the laser processing and/or the polishing” before it is fired.

Further, in the third manufacturing method, the firing step may be performed without removing the remnant membrane RF, and thereafter, the remnant membrane RF is removed by a blast processing (including the “special blast processing using elastic grains”) described above.

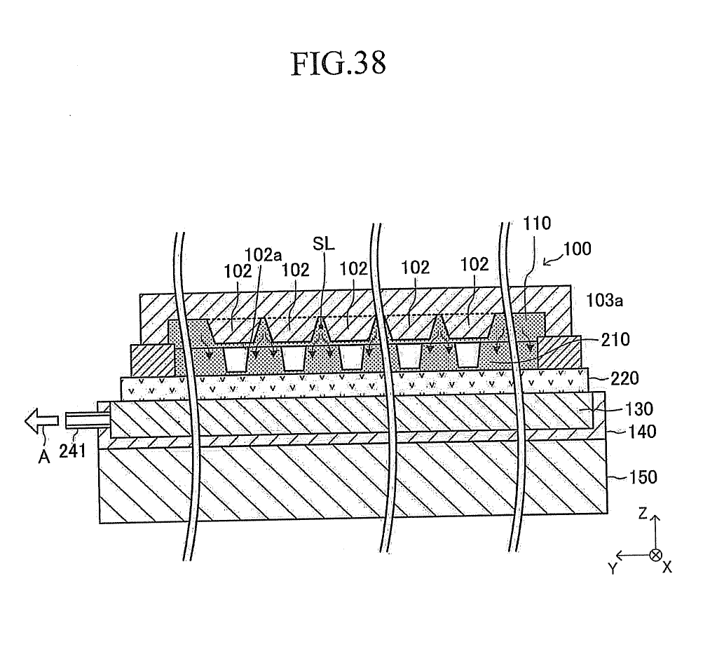

In addition, the preset invention may be implemented as a modified example shown in FIG. 38. That is, similarly to the second compact forming step of the first manufacturing method, the second compact-after-dried is formed on the second porous plate 220. Subsequently, without separating the second compact 210 which was dried from the second porous plate 220, the first mold 110 into which the slurry SL is filled is placed on the second compact 210. Then, the solvent included in the slurry filled into the first mold 110 permeates into an upper surface of the “second compact 210 which has been dried” to be evaporated so that the slurry SL is dried. Subsequently, the second porous plate 220 is released, and the first mold 100 is released. In this manner, a head body having the same shape as the head body 20A shown in FIG. 13 is formed.

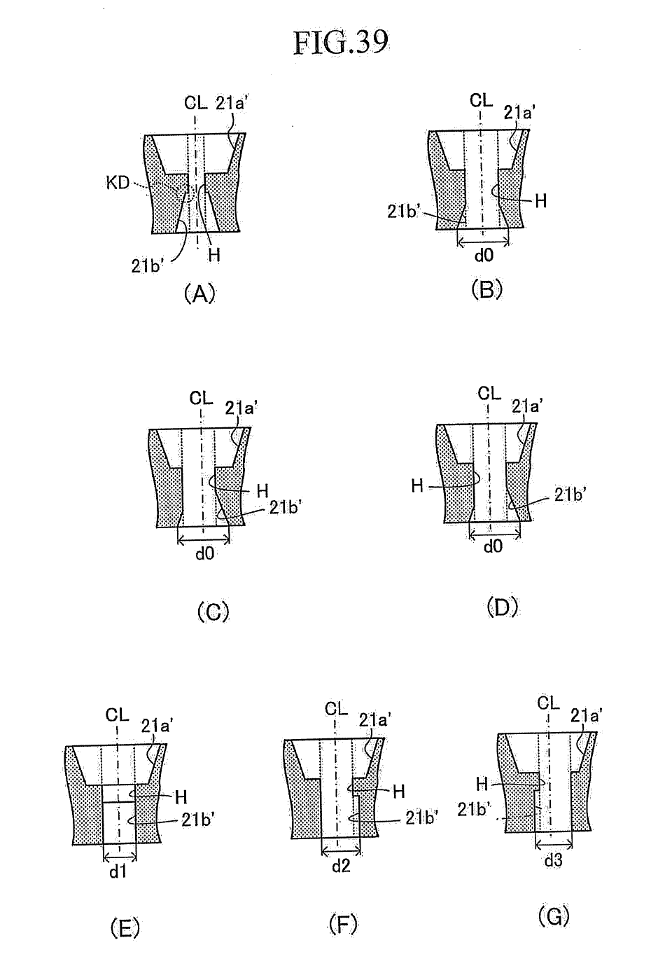

Further, in the first manufacturing method, as shown in FIG. 13 and in the (A) of FIG. 39, for example, the shape of the concave portion 21b′ is the circular truncated cone shape. In this case, when a diameter of the through hole H formed by the laser processing is relatively small, a stepwise portion is generated as shown in a circle KD with a broken line in (A) of FIG. 39. In contrast, as shown in (B) of FIG. 39, when the diameter of the through hole H formed by the laser processing and the shape of the concave portion 21b′ are designed appropriately, the nozzle section having no stepwise portion can be formed. This can decrease flow resistance of the nozzle section, and can prevent a portion where the liquid stagnates from being generated.

Further, appropriately designing the diameter of the through hole H formed by the laser processing and the shape of the concave portion 21b′ can provide the nozzle section having no stepwise portion, and can maintain a diameter of the opening at the droplet discharge side of the concave portion 21b′ at a constant value d0, even when a position of the laser processing (i.e., the central axis of the through hole H) is deviated to a certain degree from a central axis CL of the concave portion 21b′ as shown in (C) of FIG. 39. This is also applicable when the central axis of the concave portion 21b′ is deviated to a certain degree from the central axis CL of the groove section 21a′, as shown in (D) of FIG. 39.

(E) to (G) of FIG. 39 show cross-sectional views of the concave portions 21b′, when each of them has a cylindrical shape. In this case, as shown in (E) of FIG. 39, it is necessary that a position and a diameter of the concave portion 21b′ are made coincide with a position and a diameter of the through hole H formed by the laser processing, respectively, in order not to generate the stepwise portion. However, in actuality, the center of the concave portion 21b′ deviates as shown in the (F) of FIG. 39, or the position of the laser processing deviates as shown in the (G) of FIG. 39. In these cases, the stepwise portion arises, and the diameter of the opening at the droplet discharge side of the concave portion 21b′ becomes values d2 and d3, larger than a value d1. Thus, there is a possibility that a stable discharging droplets property can not be obtained. For these reasons, it is preferable that the shape of the concave portion 21b′ be the circular truncated cone shape whose diameter gradually increases in a droplet discharge direction.

Further, in place of the liquid storage chamber cover member 40, the vibration plate 30 may cover not only the upper portion of all of the concave portions 21a but also the upper portions of concave portion 22a and all of the groove sections 23a.

1. A method for manufacturing a droplet discharge head including a droplet discharge head body having a pressure chamber for storing liquid, a nozzle section communicating with said pressure chamber including:
slurry preparing step for preparing a slurry including ceramic powders, a solvent for said ceramic powders, and an organic material;
first mold preparing step for preparing a first mold including a first base portion having at least one flat surface, and a first convexity portion having a convexity which stands from said flat surface of said first base portion and has the substantially same shape as said pressure chamber, wherein a portion of said flat surface of said first base portion at which said first convexity portion does not exist and a surface of said first convexity portion constitute a molding surface;
first porous plate preparing step for preparing a first porous plate, which has at least one flat surface, and through which gases can pass;
first compact forming step for forming a first-compact-after-dried by placing said first porous plate and said first mold in such a mariner that they oppose to each other while said slurry is maintained between said flat surface of said first porous plate and said molding surface of said first mold, and drying said slurry through having said solvent included in said slurry permeate into fine pores of said first porous plate;
second mold preparing step for preparing a second mold including a second base portion having at least one flat surface, and a second convexity portion having a convexity which stands from said flat surface of said second base portion and has the substantially same shape as said nozzle section, wherein a portion of said flat surface of said second base portion at which said second convexity portion does not exist, and a surface of said second convexity portion constitute a molding surface;
second porous plate preparing step for preparing a second porous plate, which has at least one flat surface, and through which gases can pass;
second compact forming step for forming a second-compact-after dried by placing said second porous plate and said second mold in such a manner that they oppose to each other while said slurry is maintained between said flat surface of said second porous plate and said molding surface of said second mold, and drying said slurry through having said solvent included in said slurry permeate into fine pores of said second porous plate;
head-body-before-fired forming step for forming a droplet discharge head body-before-fired by joining said first compact and said second compact in such a manner that a flat portion of said first compact formed by said flat surface of said first porous plate, and a flat portion of said second compact formed by said flat surface of said second porous plate are parallel to each other; and
firing step for firing said droplet discharge head body-before-fired.

2. The method for manufacturing a droplet discharge head according to claim 1, wherein,
said head-body-before-fired forming is a step for joining said first compact and said second compact in such a manner that said flat portion of said first compact contacts with said flat portion of said second compact.

3. The method for manufacturing a droplet discharge head according to claim 2, further comprising:
other member joining step for joining a member having a through hole to a surface in a side of said second compact of said fired droplet discharge head body in such a manner that said through hole communicates with said nozzle section, after said firing step.

4. The method for manufacturing a droplet discharge head according to claim 1, wherein,
said head-body-before-fired forming step includes removing a part of a first remnant formed by said flat surface of said first porous plate and a top surface of said first convexity portion, and removing a part of a second remnant formed by said flat surface of said second porous plate and a top surface of said second convexity portion, after said first compact and said second compact are joined.

5. The method for manufacturing a droplet discharge head according to claim 2, wherein,
said head-body-before-fired forming step includes removing a part of a first remnant formed by said flat surface of said first porous plate and a top surface of said first convexity portion, and removing a part of a second remnant formed by said flat surface of said second porous plate and a top surface of said second convexity portion, after said first compact and said second compact are joined.

6. The method for manufacturing a droplet discharge head according to claim 3, wherein,
said head-body-before-fired forming step includes removing a part of a first remnant formed by said flat surface of said first porous plate and a top surface of said first convexity portion, and removing a part of a second remnant formed by said flat surface of said second porous plate and a top surface of said second convexity portion, after said first compact and said second compact are joined.
